(19) United States
(12) Patent Application Publication
(10) Pub. No.: US 2010/0011282 A1
(43) Pub. Date: Jan. 14, 2010

(54) ANNOTATION SYSTEM AND METHOD

(75) Inventors: Joe Dollard, Cheltenham (AU); Zoltan Olah, Oakleigh (AU); Tom Coleman, North Fitzroy (AU); Stephen Foley, Wonga Park (AU)

Correspondence Address: KLARQUIST SPARKMAN, LLP, 121 SW SALMON STREET, SUITE 1600, PORTLAND, OR, 97204, US

(73) Assignee: iCyte Pty Ltd., Wonga Park (AU)

(21) Appl. No.: 12/426,048

(22) Filed: Apr. 17, 2009

(30) Foreign Application Priority Data
Jul. 11, 2008 (AU) 2008903575

(51) Int. Cl. G06F 17/00; G06F 17/30; G06F 7/06; G06F 3/048

(52) U.S. Cl. 715/233; 707/102; 707/3; 715/234; 715/810

(57) ABSTRACT

A variety of technologies can be used to annotate electronic documents. In one embodiment, an annotation module is provided on a client machine as a plugin for a web browser application. The annotation module provides a user interface which allows the user to interact with the web browser application to annotate a document displayed using the browser application. Other embodiments are described.

### FIELD

The field relates to systems and methods for annotating electronic documents, and in particular, but not being limited to, electronically annotating structured documents such as web pages.

### CROSS-REFERENCE TO RELATED APPLICATION

This application claims the benefit of Australian patent application 2008903575, filed Jul. 11, 2008.

### BACKGROUND

There are many types of electronic tools (such as computers and mobile devices) that enable users to access or create various types of electronic resources (including electronic documents, web pages and video content). For example, such tools enable a user to access (e.g. via the Internet) a vast range of electronic resources created by other users. As more and more electronic resources become available, it becomes increasingly difficult to identify information that is useful or relevant to a user's needs. In particular, where an electronic resource contains a large amount of information, it becomes difficult to record and subsequently locate and retrieve a specific relevant portion of the content within that resource in a quick and simple manner.

Search engines, such as those provided by Google and Yahoo!, provide one way of searching for potentially relevant information based on keywords provided by a user. Search engines, however, may not always return relevant results. For example, the meaning of a particular keyword used in the search may vary depending on the context in which it is used, and the search engine may identify a document as potentially relevant when it includes a keyword that is used in an inappropriate context. Search engines typically index an electronic resource (or document) based on its entire contents, rather than a selected portion of that resource. Also, once the source content changes or is removed, the index of the search engine index and database changes accordingly, making it harder or impossible to locate “historical” (or deleted or changed) documents using common search engines. Thus, a user of a search engine today will get different results when carrying out the identical search in six months time.

Many browser programs, such as Microsoft Internet Explorer, Apple Safari and Mozilla Firefox, include the ability to bookmark a webpage. Typically, the bookmark feature of a browser stores the location and title of the webpage, and the date of access. For example, a user who is interested in dogs may bookmark a web page about a certain dog breeder because the user is interested in dog health tips located on that breeder's website. However, if the webpage changes or is deleted, the bookmark remains, but may no longer refers to something of interest to the user (if the bookmark link works at all). Moreover, the bookmark only identifies the whole webpage, and not the item of interest located on that webpage.

Tag-based content services (such as blogs) enable users to create content and associate that the content with one or more predefined tags representing keywords (or topics) relevant to the content. Such content can be retrieved by users based on a selection of one or more tags relevant to a user query. However, the association of tags to content can be arbitrary and is therefore error-prone. Further, if predefined tags are not used, various content creators use different tags for the same concept (e.g., “road” and “street”) making retrieval of relevant materials more difficult.

### SUMMARY

The technologies discussed above (e.g., bookmarking webpages, search engines, tagged content) are designed to help users to locate a document (such as a webpage, a spreadsheet, a textual document, an image and the like). These technologies are not useful for assisting users who have already located a relevant document, and wish to easily locate it again because of particular content in that document.

More recently, electronic “clipping” services such as Google Notebooks provide a mechanism for users to highlight and store selected portions of a live electronic resource (e.g. a web page). However, live resources such as a web page may change over time as content modifications are made, or may be deleted at a later point in time. Services such as Google Notebooks presently do not provide any mechanism for maintaining the accuracy of existing stored “clippings” (which represent selected portions of the contents in an electronic resource) if the content of the resource is later modified or deleted.

There is a need for systems that allow a user to select and annotate portions of an electronic document, and to allow the user to later search for and retrieve that document as originally annotated by the user (along with the annotations), even if the source document is later modified or deleted. Moreover, because users often use more than one computer or mobile computing device, it is desirable to allow a user to search for and access documents that the user has previously annotated, from any computer or device with an Internet connection.

In one embodiment of the invention, an annotation module is provided on a client machine as a plugin for a web browser application (e.g. Microsoft Internet Explorer). The user can access web pages using the browser application. The annotation module provides a user interface which allows the user to interact with the web browser application to annotate a document (e.g. a web page) displayed using the browser application.

The user initially enters identification and authentication data (e.g. a username and password) via the user interface, and the annotation module then communicates the identification and authentication data to an annotation server via a communications network to verify the user. The user interface is then configured to allow the user to select a portion of a document displayed using the browser application and create an annotation based on the selected portion. For example, the user may select a portion of text on a document (e.g. a web page) by highlighting that section using the mouse and cursor in a standard manner when using a graphical user interface. Once the user has selected a portion of the document, the user then identifies this selection as a portion of the document that the user wishes to annotate (e.g. by clicking on an icon that the annotation module causes to be displayed on the computer screen.)

When the user does this, the annotation module allows the user to enter information about the selected portion of the document, that is, create an annotation.

An annotation can include information that is associated with or relevant to the selected portion of the document. Typically, an annotation would include a comment or note made by the user. An annotation could also include, for example, the title of the document, the text that was selected, the date and time of the annotation, keywords or tags, and the name or user id of the person who created the annotation. In addition, for example, the annotation may define display characteristics (e.g. the highlight colour and opacity properties for marking the selected portion of the document). The annotation module can automatically obtain details of the document (e.g. the title and reference) and automatically generate or retrieves other details associated with the annotation (e.g. the date/time of creating the annotation and identity of the user who created the annotation). The user may enter additional information associated with the annotation via the user interface of the annotation module (e.g. one or more tags or keywords, a description, and select or create project name).

The annotation module sends the details associated with the selected portion of the document to the annotation server for storage in a database (or any other data storage means). The user may then make further selections if they wish.

A useful feature of the annotation module is its ability to distinguish between core resource and non-core resources of a document. The core resource may include the HTML code and CSS stylesheets of a web page. The non-core resources may include the images referenced by the webpage. The annotation module may be configured to send the core resources to the annotation server, together with references (e.g. URLs) to the non-core resources. The annotation server uses the references to retrieve the non-core resources, and stores the non-core resources with the core resources received from the annotation module.

Typically, the annotation and the associated document is stored on a central annotation server, and is associated with the user who created the annotation and/or a project.

The annotation can be view or retrieved in a number of ways. For example, the annotation module on the user's computer may allow the user (for example, by clicking on a displayed icon) to cause to be retrieved and displayed on the user's computer the last three annotations made by the user (including, for example, an image of the document and the associated annotation information). This may be displayed as a series of semi-transparent (or translucent) small images over the top of other documents, or as or in a separate file or document.

The annotations made by the user may also be accessed and displayed by navigating to a remote webpage created to access the information on the central annotation server. Thus, for example, the user may later navigate to a webpage generated by the annotation server to access, sort, filter and group the annotations made previously and to view those annotations that are pertinent to their current investigation. The user may edit or add to the annotation, or delete the annotated document. The user may view any of the annotations in their original context (for example, the document, along with the annotation, can be retrieved from the annotation server and displayed, including the section of the document selected and marked by the user when making the annotation.)

A user may decide to make his or her annotations public, private, or accessible only by a defined group of people. Thus, others may be given access to the user's annotations, and can access the annotated documents, in a similar fashion as discussed above.

The user may search the user's annotated information to find relevant documents. In an enhanced version, a user may be able to search across all public annotations of others that are accessible via the annotation server.

In a described embodiment, there is provided a system for annotating electronic documents, said system comprising at least one processor configured to:
i) access an electronic document;
ii) access a user selected portion of the contents of said document;
iii) generate annotation data for said portion, said annotation data comprising position data representing a relative location of said portion within a subset of the contents of said document;
iv) store, in a data store, data comprising document data representing the contents of said document, said annotation data, and resources data representing one or more data items referenced by said document; and
v) generate, based on at least said annotation data from said data store, a graphical display comprising a unique graphical representation of said portion.

In another described embodiment, there is provided a method for annotating electronic documents, comprising:
i) accessing an electronic document;
ii) accessing a user selected portion of the contents of said document;
iii) generating, in a computing device, annotation data for said portion, said annotation data comprising position data representing a relative location of said portion within a subset of the contents of said document;
iv) controlling a data store to store data comprising document data representing the contents of said document, said annotation data, and resources data representing any data items referenced by said document; and
v) generating, based on at least said annotation data from said data store, a graphical display comprising a unique graphical representation of said portion.

In another described embodiment, there is provided a system for annotating electronic documents, said system comprising at least one processing module configured to:
i) access an electronic document providing contents based on a structure;
ii) generate document data representing said contents, comprising data for uniquely identifying different predefined subsets of said contents based on said structure;
iii) access a user selected portion of the contents of said document;
iv) generate annotation data for said portion, said annotation data comprising position data representing a relative location of said portion within at least one of said predefined subsets;
v) control a data store to store data comprising said document data, said annotation data, and resources data representing any data items referenced by said document; and
vi) generate, based on at least said annotation data from said data store, display data representing a graphical user interface comprising a unique graphical representation of said portion.

In another described embodiment, there is provided a method for annotating electronic documents, comprising:
i) accessing an electronic document providing contents based on a structure;
ii) generating document data representing said contents, comprising data for uniquely identifying different predefined subsets of said contents based on said structure;
iii) accessing a user selected portion of the contents of said document;
iv) generating, in a computing device annotation data for said portion, said annotation data comprising position data representing a relative location of said portion within at least one of said predefined subsets;
v) controlling a data store to store data comprising said document data, said annotation data, and resources data representing any data items referenced by said document; and
vi) generating, based on at least said annotation data from said data store, display data representing a graphical user interface comprising a unique graphical representation of said portion.

In another described embodiment, there is provided a system for annotating electronic documents, comprising:
a processor component;
a display configured for displaying, to a user, a graphical user interface comprising a graphical representation of the contents of an electronic document accessed by said system;
a cursor component being selectively moveable to any position within said display based on a first user action, and being responsive to a second user action for selecting a portion of said contents shown within said display; and
an annotation component that can be selectively activated and deactivated by a user, so that when said annotation component is activated, said annotation component:
i) generates document data representing the contents of said document, comprising data for uniquely identifying different predefined subsets of said contents;
ii) in response to detecting a user selecting said portion, generates annotation data for said portion, said annotation data comprising position data representing a relative location of said portion within at least one of said predefined subsets;
iii) controls a data store to store data comprising said document data, said annotation data, and resources data representing any data items referenced by said document; and
iv) generates, based on at least said annotation data from said data store, display data representing an updated said graphical user interface comprising a unique graphical representation of said portion.

In another described embodiment, there is provided a computer program product, comprising a computer readable storage medium having a computer-executable program code embodied therein, said computer-executable program code adapted for controlling a processor to perform a method for annotating electronic documents, said method comprising:
i) accessing an electronic document;
ii) accessing a user selected portion of the contents of said document;
iii) generating annotation data for said portion, said annotation data comprising position data representing a relative location of said portion within a subset of the contents of said document;
iv) controlling a data store to store data comprising document data representing the contents of said document, said annotation data, and resources data representing any data items referenced by said document; and
v) generating, based on at least said annotation data from said data store, a graphical display comprising a unique graphical representation of said portion.

### BRIEF DESCRIPTION OF THE DRAWINGS

Representative embodiments of the present invention are herein described, by way of example only, with reference to the accompanying drawings, wherein:

FIG. 1A is a block diagram showing the components of an annotation system;

FIG. 1B is a block diagram showing another configuration of the annotation system;

FIG. 2 is a flow diagram of an annotation process performed by the system;

FIG. 3 is a flow diagram of an annotation capture process performed by the system;

FIG. 4 is a flow diagram of a digest creation process performed by the system;

FIG. 5 is a flow diagram of a resource capturing process performed by the system;

FIG. 6 is a flow diagram of a display process performed by the system;

FIG. 7 is an exemplary data structure representing user/user-project association data;

FIG. 8 is an exemplary data structure representing annotation association data;

FIG. 9 is an exemplary data structure representing user-project association data;

FIG. 10 is an exemplary data structure representing annotation/user-project association data;

FIG. 11 is an exemplary data structure representing visitation data;

FIG. 12 is an example of the HTML code in a web page;

FIG. 13 is an example of a selected portion from an electronic document;

FIG. 14 is an example of the HTML code associated with the portion in FIG. 13;

FIG. 15 is an example of the HTML code of a web page captured by the system;

FIG. 16 is an exemplary portion of a document browser display showing marked up portions of a web page document;

FIG. 17 is an exemplary portion of a summary display generated by the system;

FIG. 18 is an example of a report summary display generated by the system;

FIG. 19 is an example of a document browser display at the moment before the user selects a portion of text in the document;

FIG. 20 is an example of the changes made to the document browser display by the system after the user selects a portion of text in the document;

FIG. 21 is an example of a document browser display at the moment before the user selects a spatial portion (or region) within the document;

FIG. 22 is an example of the changes made to the document browser display by the system after the user selects a spatial portion (or region) within the document;

FIG. 23 shows an example of an access control process performed by the system;

FIG. 24 shows an example of another access control process performed by the system;

FIGS. 25 to 29 show examples of different types of graphical user interfaces that can be generated by the system.

### DETAILED DESCRIPTION OF THE REPRESENTATIVE EMBODIMENTS

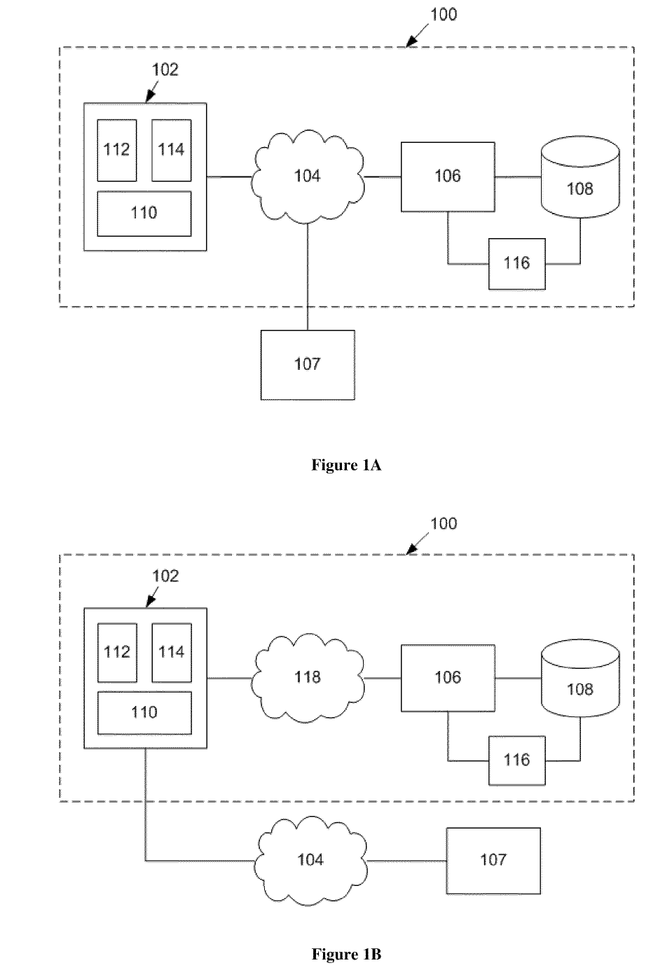

FIG. 1A is a block diagram showing a representative embodiment of an annotation system 100. The annotation system 100 in FIG. 1A includes a client device 102 that communicates with an annotation server 106 via a first communications network 104 (e.g. the Internet, a local area network, a wireless network or a mobile telecommunications network). The client device 102 may be a standard computer, a portable device (e.g. a laptop or mobile phone), or a specialised computing device for accomplishing annotation as described herein. The annotation server 106 is a server configured for receiving and processing requests from one or more client devices 102, and generating response data (e.g. including data representing an acknowledgment or web page) in response to such requests. The client device 102 can access content (e.g. representing a webpage or document) from an external content server 107 via the network 104. The annotation server 106 allows the user to generate annotation data unique to one or more selected portions of the content, and stores the content (together with any annotation data) in the database 108. The analysis server 116 performs analysis of the data stored in the database 108, and is an optional component of the system 100.

FIG. 1B shows the annotation system 100 in another representative configuration. In FIG. 1B, the client device 102 communicates with an external content server 107 to access content via the communications network 104 (as described above). The client device 102 communicates with an annotation server 106 via a second communications network 118 (such as a Local Area Network (LAN), corporate intranet, or Virtual Private Network (VPN)), where access to the second communications network 118 is restricted to users with valid access privileges or parameters (e.g. a valid user name and password, or valid IP address). The configuration shown in FIG. 1B is an optional way to deploy the annotation server 106, which could be located in the premises of an enterprise client. Therefore, any annotation data (as described below) can be stored on a locally accessible server as opposed to an off-site (or global) server as shown in FIG. 1A. This enables users to potentially access the annotation server 106 via an intranet/ethernet (which may be a highly secure network) without having access to an external public network (such as the Internet).

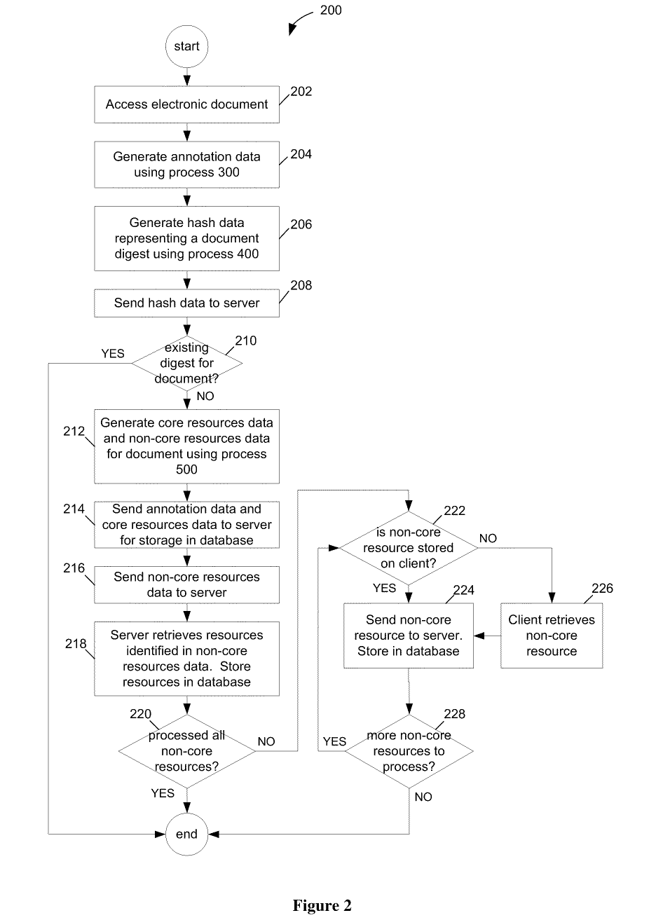

The client device 102 includes at least one processor 110 that operates under the control of commands or instructions generated by a browser module 112 and annotation module 114. The annotation server 106 includes at least one processor that operates under the control of commands or instructions from any of the modules on the annotation server 106 (not shown in FIG. 1A). In a representative embodiment, the processors in the client device 102 and annotation server 106 cooperate with each other to perform the acts in the processes shown in FIG. 2 to 6 (e.g. under the control of the browser module 112, annotation module 114 and the modules on the annotation server 106). In another representative embodiment, the acts performed by the annotation server 106 may instead be performed on the client device 102. The term processing module is used in this specification to refer to either a collection of one or more processor, one or more hardware component of a device, or an entire device that is configured for performing the acts in the processes shown in FIG. 2 to 6.

The browser module 112 controls the processor 110 to access and display an electronic document, such as in response to user input received via a graphical user interface for the client device 102. The electronic document may be stored locally on the client device 102 or retrieved from an external content server 107 via a communications network 104. The external content server 107 may comprise of one or more sources of information external to the system 100 (such as one or more web servers, web services, file servers or databases that provide information accessible by the system 100).

An electronic document contains data representing information (or content) in an electronic form that can be understood by a user. The data in an electronic document may be prepared or stored in a structured format. For example, an electronic document may include data representing the information in the form of text, according to a structured language (e.g. based on the eXtensible Markup Language (XML) or the HyperText Markup Language (HTML)), or as data prepared for display or manipulation by any application including for example stored data for use in a word processing application (such as a Microsoft Word document file and Rich Text Format (RTF) file), stored data for use in a spreadsheet application (such as a Microsoft Excel spreadsheet file), and a Portable Document Format (PDF) file. The browser module 112 could be any tool used for viewing an electronic document (e.g. a web browser application, word processor application, spreadsheet application, PDF document viewer application, or an interoperable module for use with any such applications).

The annotation module 114 works in conjunction with the browser module 112. The annotation module 114 responds to user input for performing a selection (e.g. by a user interacting with a graphical user interface for the client device 102) by controlling the processor 110 to retrieve attributes corresponding to one or more user selected portions of the contents within an electronic document as accessed by the browser module 112. Each selected portion of the document can be referred to as an annotation. The annotation module 114 also generates data including:
document data representing the contents of the document (e.g. an object representation representing the contents of the document—including text and graphics—in connection with any structural components, and display or formatting attributes, of the document),
annotation data representing one or more characteristics specific to each user selected portion of the document (e.g. including data representing a relative location of a particular user selected portion within a predefined portion of the document), and
resources data representing one or more data items referenced by the document (e.g. for core and non-core resources as described below).

A data item refers to data that represents a discrete or useful unit of information which can be understood by a user. For example, a data item may represent an image, video, or a data or binary file. For each selected portion of the document, the characteristics represented by the annotation data specific to that portion may include: (i) an identification of at least the smallest set of one or more predefined portions of the document that can wholly contain the selection (also referred to a subset), (ii) the relative location of the selection within that subset, (iii) any content (e.g. text or underlying code) at least within the selection, and (iv) attributes for defining any display properties (e.g. font colour, font type, font size, etc.), display configuration and/or state of the selected portion at the time when the selection was made. For example, a web page document may include a dynamic panel (containing text) that appears and disappears from view depending on how the user interacts with the web page document. If the user selects the text on the dynamic panel, the annotation data for the selected text may include attributes indicating that the dynamic panel was in view at the time of making the selection.

The annotation module 114 controls the processor 110 to send the document data, annotation data and resources data for the electronic document to the annotation server 106 for processing and storage in the database 108. The annotation module 114 controls the processor 110 to send requests to the annotation server 106. The annotation module 114 also receives response data from the annotation server 106 and generates, based on the response data, display data representing (or for updating) a graphical user interface on a display (not shown in FIGS. 1A and 1B) of the client device 102. In a representative embodiment, the annotation module 114 is implemented as a plug-in component (e.g. an ActiveX component, dynamic link library (DLL) component or Java applet) that is interoperable with the browser module 112. The annotation module 114 may include code components (e.g. based on Javascript code) for controlling the browser module 112 to determine or modify one or more parameters defining a display criteria or characteristic (e.g. the highlighting of a selected portion) for each annotation respectively, and/or determining the relative location of each annotation within the contents of the document. The annotation module 114 can also be selectively activated or deactivated by a user (e.g. by configuring options in the browser module 112 to enable or disable a plug-in component providing the functionality of the annotation module 114). For example, when the annotation module 114 is activated, both the browser module 112 and annotation module 114 can operate together perform annotation functions as described in this specification (e.g. the processes shown in FIGS. 2 to 6). When the annotation module 114 is deactivated, the browser module 112 is unable to perform any such annotation functions.

The browser module 112 and annotation module 114 may be provided by computer program code (e.g. in languages such as C, C# and Javascript). Those skilled in the art will appreciate that the processes performed by the browser module 112 and annotation module 113 can also be executed at least in part by dedicated hardware circuits, e.g. Application Specific Integrated Circuits (ASICs) or Field-Programmable Gate Arrays (FPGAs).

The annotation server 106 may receive and process requests from one or more client devices 102, and generate response data (e.g. representing an acknowledgment or web page) in response to such requests. The response data is sent back to the client device 102 that made the request. The annotation server 106 communicates with a database 108. The database 108 (or data store) refers to any data storage means, and may be provided by way of one or more file servers and/or database servers such as MySQL or others. When the annotation server 106 receives a request that requires retrieving data from the database, the annotation server 106 queries the database 108 and generates, based on the results from the database 108, response data that is sent back to the client device 102.

Each document annotated by the annotation system 100 is stored in the database 108 in association with a unique document identifier for that document. The document may belong to a project, in which case the database 108 stores the relevant document identifier in association with a unique project identifier for the project to which the document relates. Each project may have one or more different participants, in which case the database 108 may store the relevant project identifier in association with one or more different user identifiers for each of the participants. A user also may participate in one or more different projects, and so the database 108 may store each user identifier in association with one or more different project identifiers.

A project may have user access restrictions for controlling the type of users who can access the annotations for that project. For example, the annotation system 100 may be configured so that the documents for a project that is classified as “public” will be accessible by all users of the annotation system 100. However, the documents for a project that is classified as “private” may only be accessible by the participants of that project. As another example, the annotation system 100 may be configured so that user access restrictions can be set for individual documents (or for specific documents), such that any user who has access to the document is able to configure the access restrictions of the document for “public” or “private” access.

FIG. 2 is a flow diagram of an annotation process 200 performed jointly by the annotation server 106 and the client device 102 (under the control of the annotation module 114). The annotation process 200 begins at 202 where the client device 102 accesses an electronic document (e.g. from the content server 107). At 204, the client device 102 generates annotation data using the annotation capture process 300. The annotation data represents the characteristics specific to each selected portion of the document.

At 206, the client device 102 generates hash data representing a document digest (which uniquely represents the document) using the digest creation process 400. At 208, the client device 102 sends the hash data to the annotation server 106 for processing. At 210, the annotation server 106 determines, based on the hash data, whether the same document exists in the database 108. If so, process 200 ends. Otherwise, 210 proceeds to 212, where the annotation server 106 sends a confirmation message to the annotation module 114 on the client device 102 indicating that the document does not exist in the database 108. The client device 102 responds to the confirmation message by generating core resources data and non-core resources data using the resource capturing process 500. The core resources data represents one or more data items that are used for defining the display attributes of the document (e.g. the HTML code of a web page and any CSS style sheets). The non-core resources data represents one or more data items (e.g. images, videos, or binary files etc.) referenced by the document that, for example, can be rendered for display or otherwise incorporated as part of the document.

At 214, the client device 102 sends the annotation data (created at 204) and core resources data (created at 212) to the annotation server 106 for storage in the database 108. At 216, the client device 102 sends the non-core resources data (created at 212) to the annotation server 106. At 218, the annotation server 106 attempts to retrieve one of the data items (e.g. stored on an external content server 107) identified in the non-core resources data (e.g. images referenced in the document). Once retrieved, the data item is stored in the database 108 in association with the corresponding annotation.

At 220, the annotation server 106 determines whether all of the data items identified in the non-core resources data have been retrieved and stored in the database 108. If so, process 200 ends. Otherwise, 220 proceeds to 222, where the annotation server 106 sends a query for one or more specified data items to the client device 102. In response to the query, the client device 102 selects one of the specified data items and determines whether that data item is stored locally on the client device 102 (e.g. in a browser cache). If so, at 224, the client device 102 sends the specified data item to the annotation server 106 which stores the data item in the database 108 in association with the corresponding annotation. Otherwise, at 226, the client device 102 requests the specified data item from a source (e.g. the content server 107). The client device 102 then (at 224) sends the retrieved specified data item to the annotation server 106 for storage in the database 108.

At 228, the client device 102 determines whether all of the specified data items identified in the query have been retrieved and sent to the annotation server 106. If so, process 200 ends. Otherwise, 228 proceeds to 222 to retrieve another specified data item.

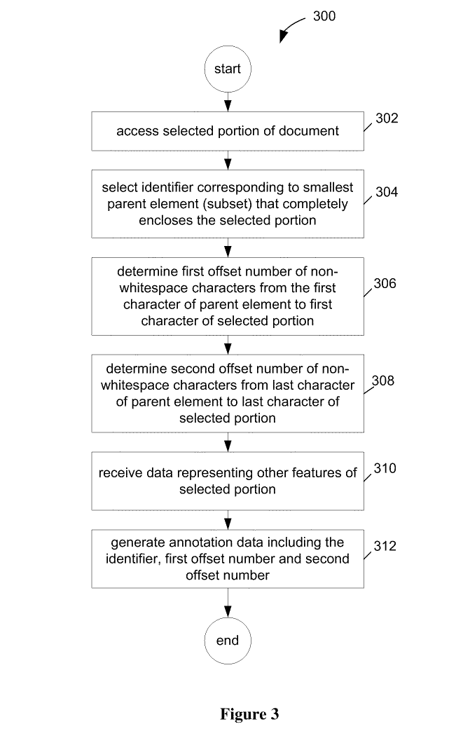

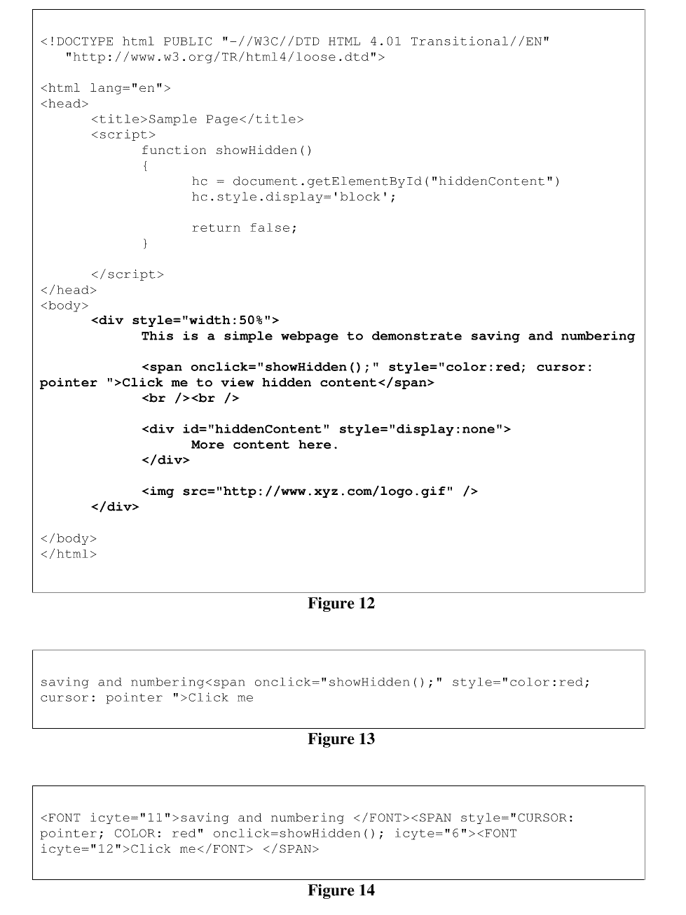

FIG. 3 is a flow diagram of an annotation capture process 300 performed on the client device 102 (under the control of the browser module 112 and annotation module 114). The annotation capture process 300 begins at 302 where the annotation module 114 controls the processor 110 to instruct the browser module 112 to return a selection object representing the contents corresponding to each different selected portion of the document. For example, a user may select one or more portions of a document by highlighting some of the content in the document using a cursor. Alternatively, the user may select a spatial region corresponding to a portion of the document using a cursor. The selection object returned by the browser module 112 includes the highlighted content (e.g. text and images) for each of the selected portions, including any underlying formatting attributes or code attributes for each of the selected portions. Alternatively, the selection object returned by the browser module 112 includes coordinate data representing a plurality of vertical and horizontal coordinate pairs for defining a selection boundary covering the region of the document selected by the user. For example, the coordinate data may represent the vertical and horizontal coordinates of a start position and end position defining a rectangular spatial region of the document selected by the user. FIG. 13 shows an example of the data represented by a selection object based on a selected portion from a web page as shown in FIG. 12. If the selection object represents multiple selected portions, 302 selects one of the selected portions for processing, and process 300 is repeated separately for each selected portion represented by the selection object.

At 304, the annotation module 114 accesses an object representation of the document, where each object represents a subset of the contents of the document. Each subset may represent a portion of the content of the document, where for example, a different subset represents a different paragraph of text in a document. One subset may overlap or include content that is associated with another subset of the same document, such as where a subset (representing a section of a document) contains one or more different paragraphs of text and each paragraph is itself identifiable as a subset of that document. For example, if the document is a web page, the object representation of the web page is the Domain Object Model (DOM) representation of the web page generated by the browser module 112. Each node in the DOM representation represents an object. The annotation module 114 modifies the object representation to include a unique identifier (e.g. a unique attribute and value pair) for each object. For example, as shown in FIG. 14 (which shows an example of the HTML code output generated by the annotation module 114 based on the webpage in FIG. 12), the <FONT> object and <SPAN> object each includes an attribute called “iCyte”, and a unique numeric identifier is assigned to the iCyte attribute for each object. The annotation module 114 then selects the identifier for the object (or parent element) that completely encloses the selected portion. Referring to the examples in FIGS. 12 and 13, the selected portion shown in FIG. 13 is completely enclosed by the <DIV> object (shown in bold) in FIG. 12. Accordingly, in this example, the annotation module 114 selects the object identifier corresponding to the <DIV> object as the parent element at 304.

At 306, the annotation module 114 determines a first offset number representing a number of non-whitespace characters from the first (non-whitespace) character of the parent element to the first (non-whitespace) character of the selected portion.

At 308, the annotation module 114 determines a second offset number representing a number of non-whitespace characters from the last (non-whitespace) character of the parent element to the last (non-whitespace) character of the selected portion.

At 310, the annotation module 114 may receive other supplementary data (e.g. provided by a user or automatically determined by browser module 112 based on properties of the document or by the annotation module 114 based on properties of a user as stored in the database 108) representing features of the selected portion. For example, the supplementary data may include one or more of the following:
title data representing the title of the document;
date and time data representing the date and/or time of creating the annotation;
reference data representing a reference location (e.g. URL) of the document;
author data representing a user who annotated the selected portion;
tag data representing one or more keywords (or unique topic identifiers) relevant to the selected portion (and it may be possible to limit each tag to a keyword contained in a predefined list of keywords); and
description data representing a text description (or note) relating to the selected portion.

The tag data and description data may be generated directly based on user input into the client device 102. The title data, date and time data, reference data and author data are preferably automatically retrieved from the annotation module 114 or browser module 112.

At 312, the annotation module 114 generates annotation data (representing an annotation of a document) including the object identifier, first offset number, second offset number and any other supplementary data. The annotation data may also include selection data representing at least the contents within the selected portion of the document. FIG. 14 shows an example of the selection data generated based on the contents of a selected portion as represented by the code shown in FIG. 13. The selected portion in FIG. 13 does not represent valid HTML code as the <SPAN> tag is not properly closed. However, the selection data in FIG. 14 preferably includes additional tags to close to <SPAN> tag and also <FONT> tags to capture any display attributes corresponding to the text portions of the selection. In a representative embodiment, the selection data corresponding to the selected portion is generated by the browser module 112. The annotation data is sent to the annotation server 106 for storage in the database 108 in association with a unique identifier associated with the annotation.

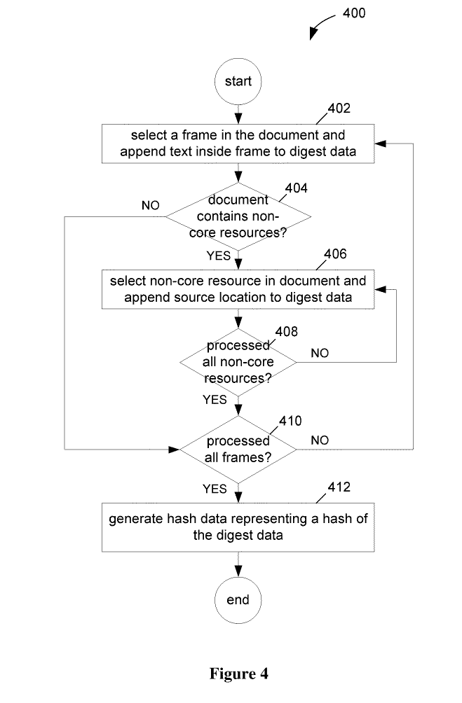

FIG. 4 is a flow diagram of a digest creation process 400 performed on the client device 102 (under the control of the annotation module 114). A document digest uniquely identifies each document based on the characteristics of the document, and is used by the annotation server 106 to determine whether any two documents are considered identical. Preferably, the digest creation process 400 takes into account key characteristics of the document which are resilient to minor layout changes to the document.

The digest creation process 400 begins by setting the digest data to represent an empty string, and then (at 402) selecting a frame of the document and adding data representing the text inside the selected frame to the digest data. Most documents consist of a single frame. If a document (such as web pages) consists of multiple frames, each frame is separately processed using 402 to 408 of process 400.

At 404, the annotation module 114 determines whether the document contains or references any non-core resources. If there are none, a different frame (if any) is selected at 410 for processing. Otherwise, at 406, a non-core resource contained or referenced in the document is selected, and the source location of the non-core resource (e.g. only image resources referenced in the document) is appended to the digest data. At 408, the annotation module 114 determines whether all of the non-core resources relating to the document have been processed. If not, 406 selects another non-core resource for processing. Otherwise, 408 proceeds to 410.

At 410, the annotation module 114 determines whether all frames of the document have been processed. If not, 402 selects another frame in the document for processing. Otherwise, 410 proceeds to 412 to generate hash data representing a hashed representation of the digest data (e.g. using a suitable hashing algorithm, such as SHA1). Process 400 ends after 410.

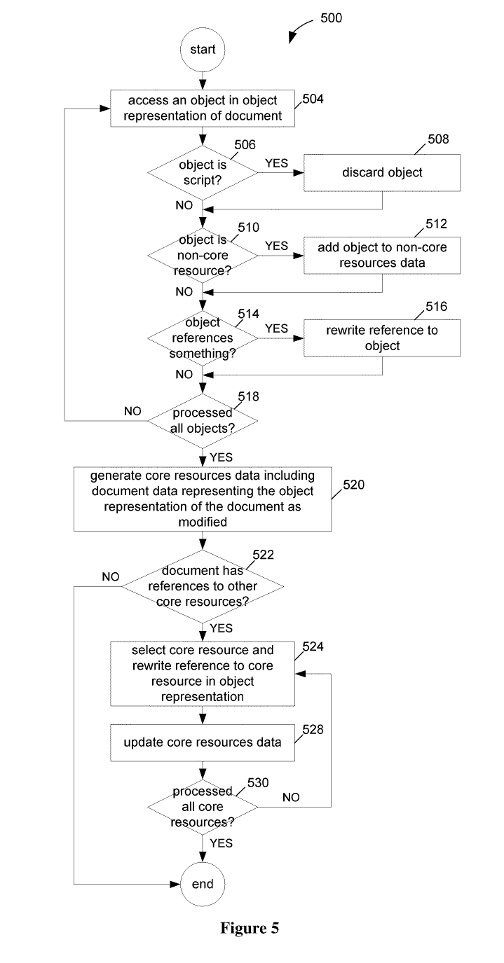

FIG. 5 is a flow diagram of a resource capturing process 500 performed on the client device 102 (under the control of the annotation module 114). The resource capturing process 500 begins at 504, where the annotation module 114 selects an object in the object representation of the document.

At 506, the annotation module 114 determines whether the selected object corresponds to a script component (e.g. Javascript, VBscript, Visual Basic Word Macro code, etc.). Preferably, any type of script present in <script> tags are removed. If not, 506 proceeds to 510. Otherwise, the object is discarded at 508, and the process proceeds to 510.

At 510, the annotation module 114 determines whether the selected object corresponds to a non-core resource. If not, 510 proceeds to 514. Otherwise, at 512, a reference to the selected object (e.g. a URL) is added to the non-core resources data which represents a list of non-core resources associated with the document, and the process proceeds to 514.

At 514, the annotation module 114 determines whether the selected object corresponds to a reference to another item (e.g. a link to an image external to the document). If not, 514 proceeds to 518. Otherwise, at 516, the selected object is modified so that the reference refers to a location of the item when stored in the database 108, and the process proceeds to 518.

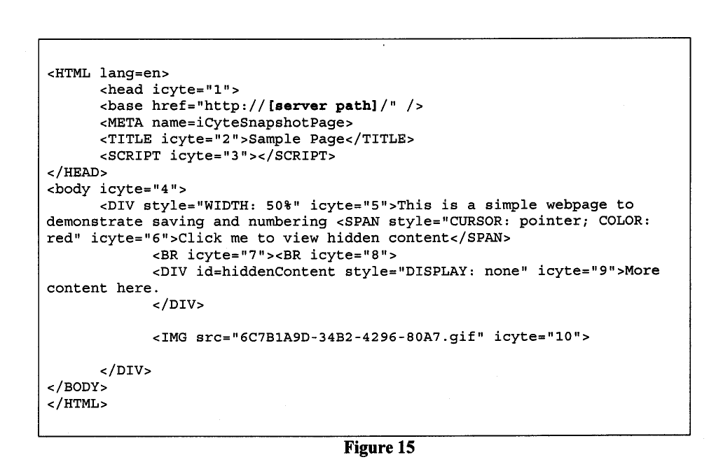

At 518, the annotation module 114 determines whether all objects in the document have been processed. If there are more objects to process, a different object is selected at 504 for processing. Otherwise, 518 proceeds to 520. At 520, the annotation module 114 generates core resources data including document data representing an object representation of the document as modified by process 400 (e.g. as shown in FIG. 15).

At 522, the annotation module 114 determines whether the document references other core resources which define display attributes for the document (e.g. CSS style sheets). If there are none, process 500 ends. Otherwise, at 524, the annotation module 114 modifies the document data so that any reference to core resource (e.g. the URL to a core resource) refers to a location of the corresponding core resource when it is retrieved and stored in the database 108. At 528, changes to the document data are saved, which includes updates to the core resources data to include modified references to the core resources (e.g. a CSS style sheet) as stored in the database 108. At 530, the annotation module 114 determines whether all of the references to core resources for the document have been processed as described above. If not, a different core resource data item is selected at 524 for processing. Otherwise, process 500 ends.

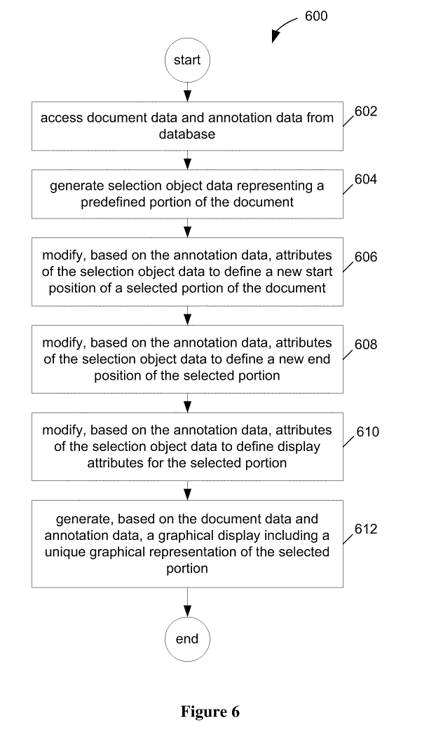

FIG. 6 is a flow diagram of a display process 600 performed on the client device 102 (e.g. under the control of the browser module 112 and annotation module 114). The display process 600 begins at 602, where the annotation module 114 sends a request to the annotation server 106 to provide (based on a document identifier uniquely representing an annotated document stored in the database 108) the document data, and the annotation data (e.g. representing one or more annotations) for the document identified in the request.

At 604, the annotation module 114 generates, based on the annotation data for the document, a selection object representing the selected portion of the document as annotated by the user. For example, the selection object may represent the content covered by the parent element identified in the annotation data. At 606, the annotation module 114 modifies the start position attribute of the selection object so that the new start position is offset by a number of non-whitespace characters equal to the first offset number represented by the annotation data. At 608, the annotation module 114 modifies the end position attribute of the selection object so that the new end position is offset by a number of non-whitespace characters equal to the second offset number represented by the annotation data.

Alternatively, if the selection portion covers a portion of an image (e.g. a portion of a page of a PDF document displayed as an image), the selection object generated at 114 may represent a display object (e.g. a translucent graphical layer) for display over the selected portion of the image. The display object may be defined by one or more coordinate positions relative to a reference point in the document. For example, the display object may represent a rectangular box that is defined by two coordinate pairs (representing an upper vertical and horizontal coordinate position, and a lower vertical and horizontal coordinate position). 606 and 608 can then adjust the coordinate positions for the display object so that the display object covers an area of the document as selected by the user.

At 610, the annotation module 114 modifies one or more attribute of the selection object for defining one or more display criteria to be applied to the selection object. Display criteria may include one or more of the following:
font type;
font size;
font colour;
background colour corresponding to the content or area covered by the selection object; and
a visual embellishment (e.g. opacity, colour or border attributes) adjacent to (or surrounding) the content or area covered by the selection object.

At 612, the browser module 114 generates (based on the document data, resources data and the modified selection object) display data representing a graphical user interface including a graphical representation of the document with a unique graphical representation of the one or more user selected portions (or annotations) of the document. The graphical representation of a selected portion (or annotation) of the document is unique if the selected portion is displayed in a manner that is different to the graphical representation of another part of the document that has not been selected as an annotation. For example, if the document is a web page and the selection object includes an image, the annotation module 114 may create a new display object (e.g. a new translucent <DIV> object in the object representation of the document) that covers the image defined in the selection object, and the annotation module 114 then modifies the display criteria of the display object (e.g. set to a particular colour) for display by the browser module 112.

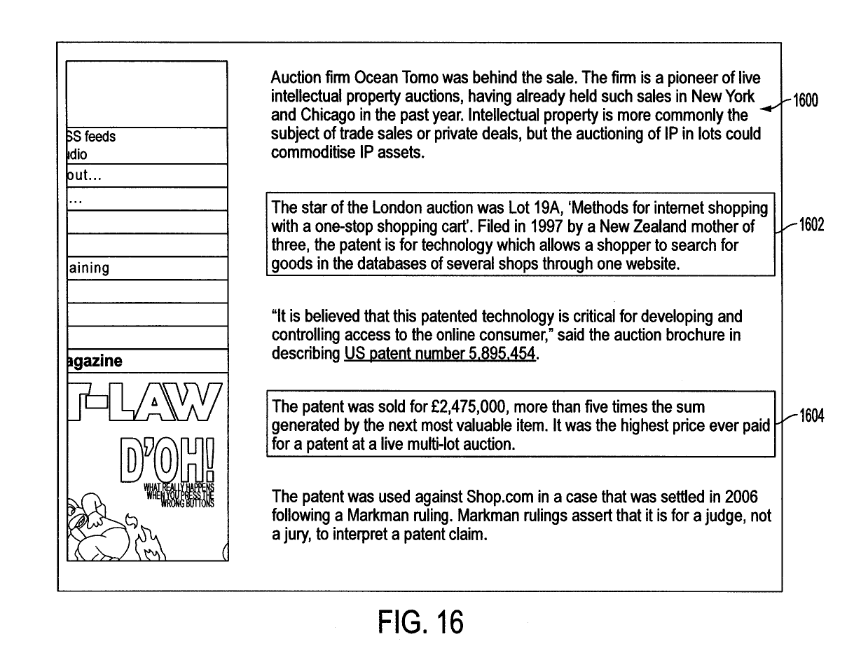

FIG. 16 shows an example of a portion of a document browser display 1600 generated by the client 102 based on the display data from the browser module 112. The display 1600 shows a representation of the document (as captured by the annotation system 100) including two different selected portions 1602 and 1604 of the document. The browser module 112 prepares the text corresponding in each selected portion 1602 and 1604 for display with “highlighting” (e.g. on a yellow background).

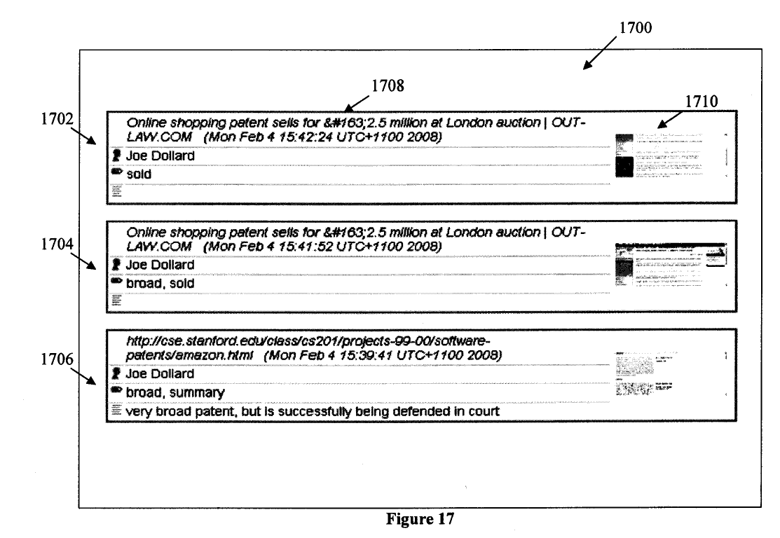

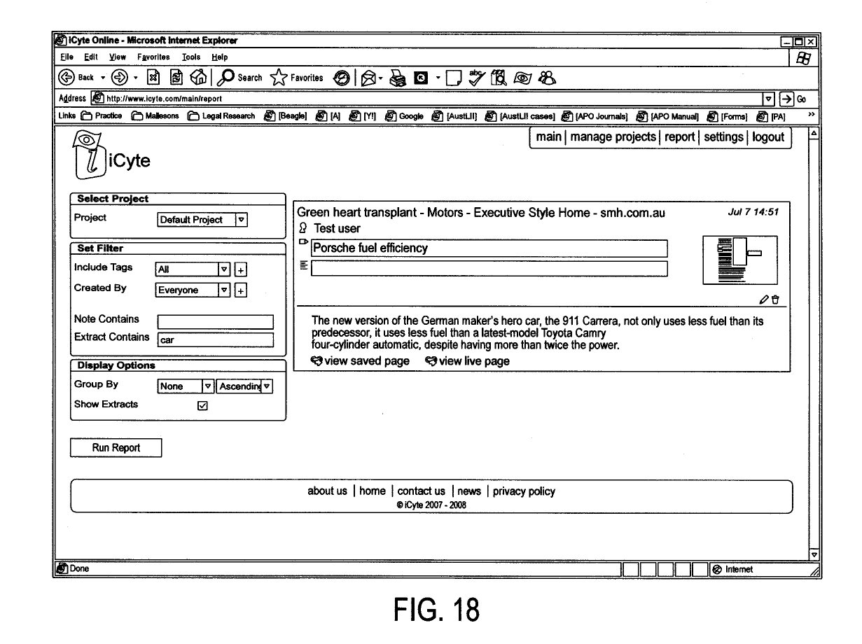

FIG. 17 shows another example of a portion of a summary display 1700 generated by the client 102 based on the display data from the browser module 112. The display 1700 represents a summary view of the data associated with different annotations 1702, 1704 and 1706 prepared by the same author. For each annotation, the display 1700 displays information including the document title, annotation creation/capture date and time, one or more tags (or topics) relating to the document, and a text description of the document. Such information may be derived from the supplementary data included in the annotation data for an annotation. FIG. 18 is an example of a report summary display generated by the client 102 based on data received from the annotation server 106. The summary display shown in FIG. 18 includes one or more entries showing the annotation data for one or more annotations, which may be retrieved based on the project, filter and/or display parameters defined using the report summary display.

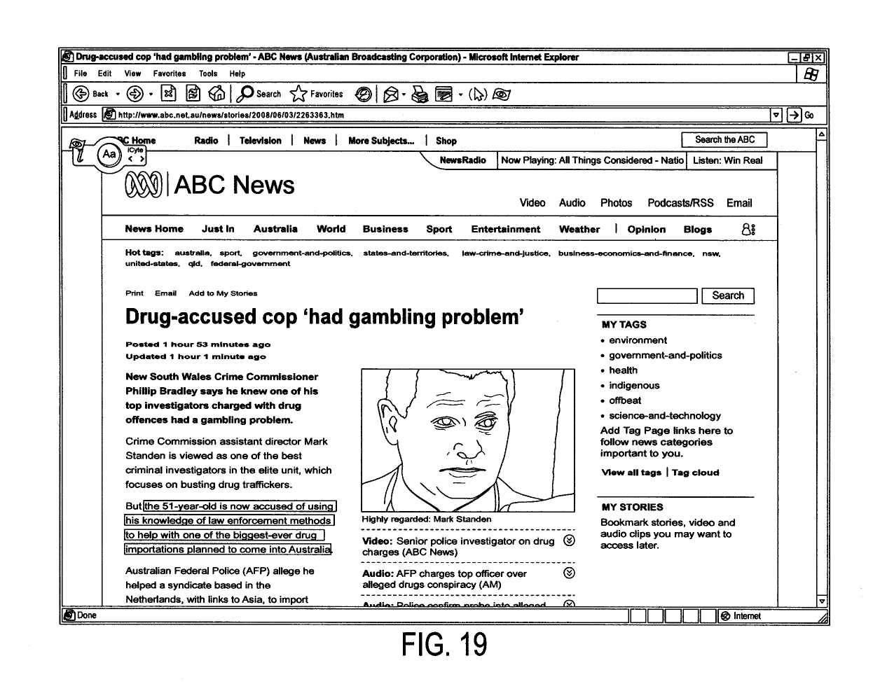

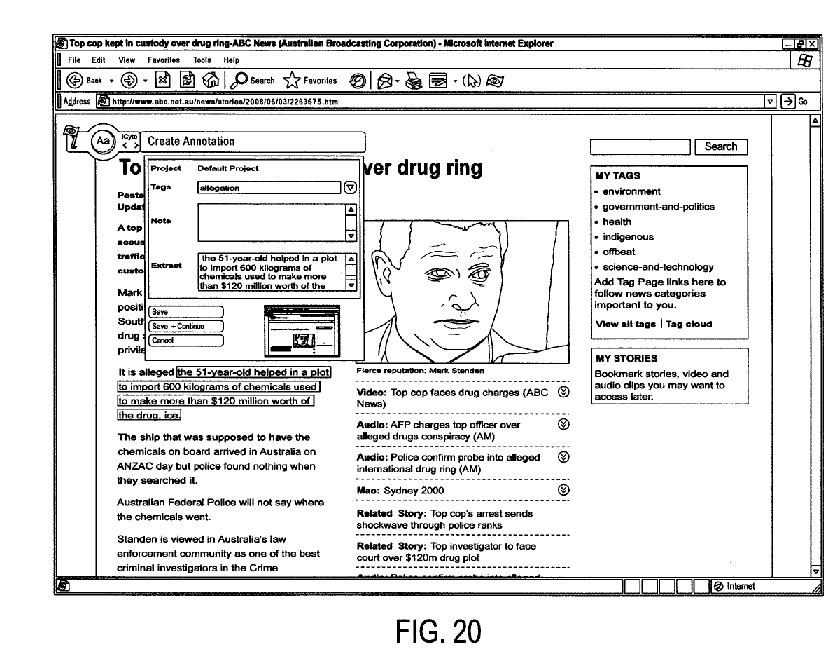

As examples of the types of display output that may be represented by the display data generated by the system 100, FIG. 19 shows an example of a document browser display (generated by the browser module 112 when the annotation module 114 has been activated) at the moment before the user selects a portion of text in a document (e.g. when a user has clicked on a mouse button and dragged the mouse cursor over an area of text in the document but has not yet confirmed the selection by releasing the mouse button). FIG. 20 is an example of the changes to the document browser display shown in FIG. 19 (made under the control of the annotation module 114) after the user confirms the selection of a portion of text in the document to the annotation module 114 (e.g. after the user releases the mouse button to confirm the selection).

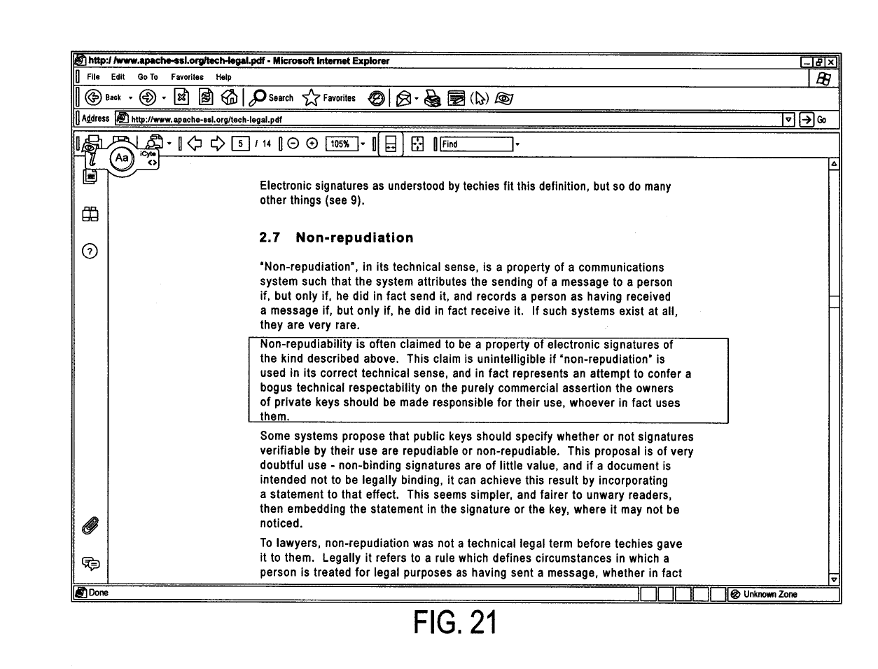

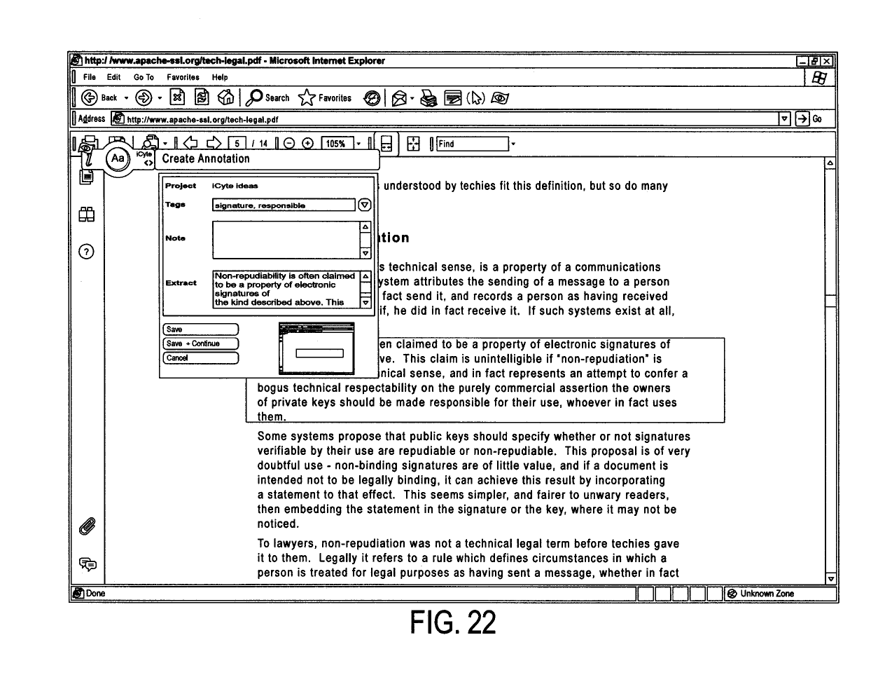

As a further example, FIG. 21 is an example of a document browser display (generated by the browser module 112 when the annotation module 114 has been activated) at the moment before the user selects a spatial portion (or region) within a document (e.g. when a user has clicked on a mouse button and dragged the mouse cursor over an area of text in the document but has not yet confirmed the selection by releasing the mouse button). FIG. 22 is an example of the changes to the document browser display shown in FIG. 20 (made under the control of the annotation module 114) after the user confirms the selection of a spatial portion (or region) within the document to the annotation module 114 (e.g. after the user releases the mouse button to confirm the selection).

The annotation system 100 can generate other types of graphical displays based on the response data generated by the annotation server 106 in response to queries from the client device 102. For example, either the annotation module 112 or annotation server 106 of the system 100 can generate a graphical display or web page including one or more annotations (in a format similar to the display 1700) which relate to one or more tags, keywords, topics in the query, author names, or reference locations for a website being annotated.

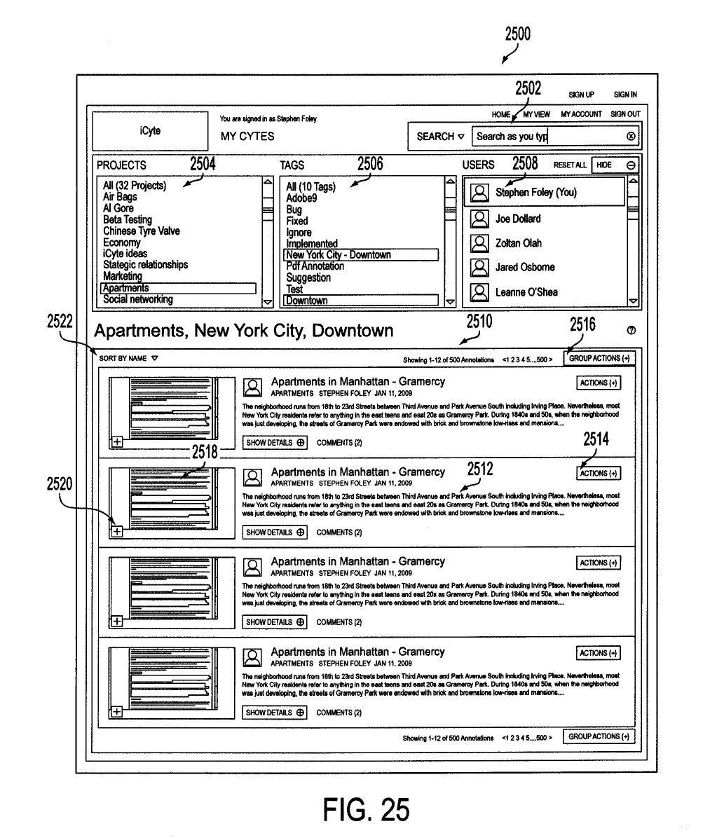

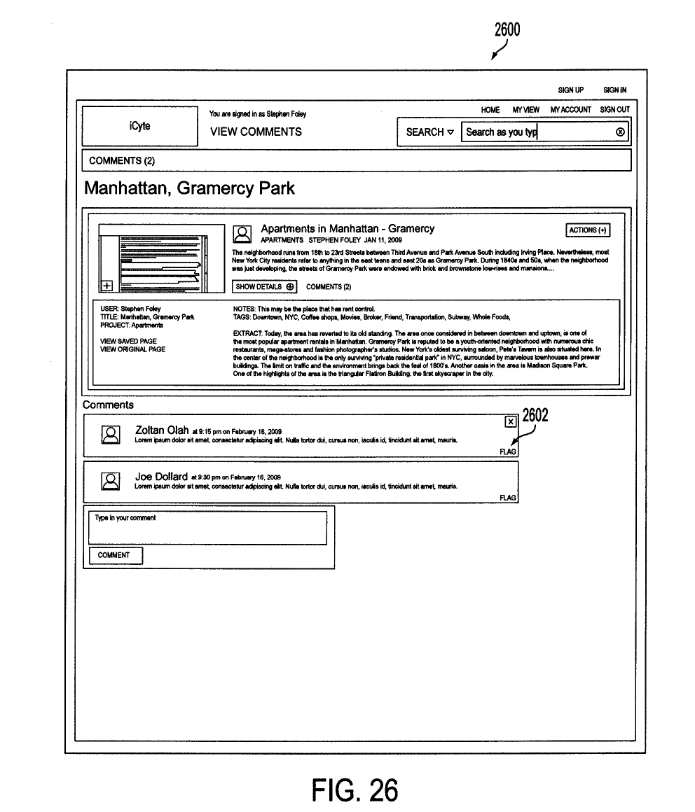

FIGS. 25 to 29 show examples of different types of graphical user interfaces that can be generated by the client 102 (e.g. using the browser module 112). FIG. 25 shows a search interface 2500 that enables a user to search for and review annotations of annotated documents stored in the database 108. The search interface 2500 may include (i) a text box 2502, (ii) one or more selection menus 2504, 2506 and 2508, and (iii) a results display area 2510. A user can enter one or more characters into the text box 2502 to form one or more keywords for a search. In response to detecting a character being entered into the text box 2502, the client 102 transmits to the annotation server 106 data representing one or more keywords (e.g. formed by delineating the string entered in the text box 2502 by any space characters in that string) for searching the database 108 for annotations containing any (or all of) those keywords. A user can also search for and review annotations based on a selection of one or more menu options in any of the selection menus 2504, 2506 and 2508. The menu options in a first selection menu 2504 may represent different annotation projects that a user is participating in. The menu options in a second selection menu 2506 may represent tags associated with the projects listed in the first selection menu 2504. The menu options in a third selection menu 2508 may represent other users that are also participating in the projects listed in the first selection menu 2504. In response to detecting a selection being made in any of the selection menus 2504, 2506 and 2508, the client transmits to the annotation server 106 data representing the selection made for searching the database 108 for annotations relating to any of the projects, tags or users selected by the user.

The annotation server 106 searches the database 108 for relevant annotations based on the keywords and/or selections provided by the user. The annotation server 106 then generates response data including results data representing details of any relevant annotations found in the database 108 and sends this to the client 102. The client 102 generates an updated search interface 2500 including search results in the results display area 2510 populated based on the results data.

The results display area 2510 may contain any number of annotation entries 2512. Each annotation entry 2512 represents an annotation (or document) that is relevant to the keywords, selections or other parameters provided as the basis of the search. The annotation entries 2512 can be arranged (or sorted) in any order based on one or more of the following:
relevance to the keywords used in the search;
chronological (or reverse chronological) order (e.g. by date);
alphabetical (or reverse alphabetical) order by the name for each annotation;
alphabetical (or reverse alphabetical) order by project name;
alphabetical (or reverse alphabetical) order by user name; and
alphabetical (or reverse alphabetical) order by tags.

It should be noted that the annotation entries 2512 can be arranged based on other factors, such as ratings, total number of comments for each annotation and so on. The search interface 2500 includes a sort control component 2522 that is selectable by a user (e.g. in response to a mouse click). When a user selects the sort control component 2522, the system 100 is configured (e.g. under the control of the browser module 112) to generate an updated search interface 2500 including a menu (not shown in FIG. 25) with one or more user selectable options (e.g. selectable in response to a user action such as a mouse click). Each of these options configures the system 100 to generate an updated search interface 2500 with the annotation entries 2512 in the results display area 2510 sorted based on a different order (as described above).

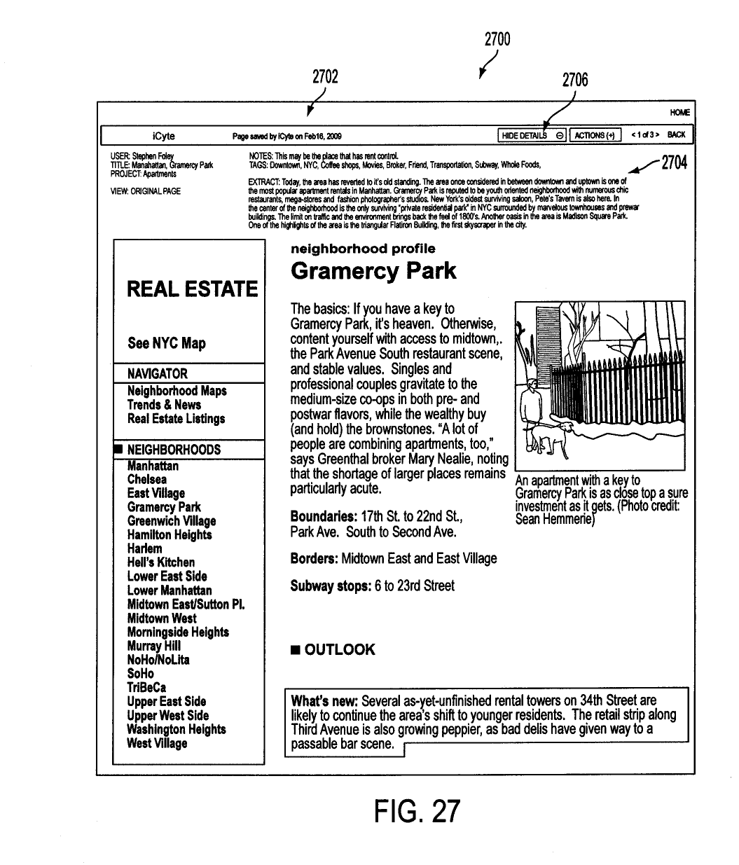

Each annotation entry 2512 shown in the results display area 2510 includes a graphical representation 2518 of at least a portion of the corresponding annotated document. This feature can help users more easily identify relevant annotations. For example, this feature can be particularly useful where a user recalls making an annotation on a document having a special graphical design/arrangement, or having a particular picture in the document. Each graphical representation 2518 may include a selection component 2520 for receiving input in response to a user action (e.g. a mouse click). For example, the graphical representation 2518 contains a button with a plus “+” sign that, in response to detecting a user action (e.g. a mouse click), configures the annotation system 100 to generate an updated search interface 2500 (e.g. as shown in FIG. 27) for displaying only the annotated document corresponding to the annotation entry 2512.

Each annotation entry 2512 may have a corresponding “Actions” button 2514. In response to the Actions button 2514 detecting a user action (e.g. a mouse click), the annotation system 100 is configured (e.g. under the control of the browser module 112) to generate an updated search interface 2500 including a primary menu selection component (not shown in FIG. 25) that contains one or more user selectable primary menu options. Each primary menu option is selectable in response to a user action (e.g. a mouse click), and each primary menu option enables the user to configure the annotation system 100 to perform a different function. For example, after selecting the Actions button 2514, the options in the primary menu selection component enables the user to conveniently configure the system 100 to do one or more of the following:
add the annotation to one of the user's existing projects;
change the description, tags or other attributes relating to the annotation;
move the annotation to another of the user's existing projects;
make a duplicate copy of the annotation;
send a link to the annotation (e.g. by email or other messaging means); and
delete the annotation.

The ability to change or delete an annotation may be restricted to the user who created the annotation, or to authorised users (such as by a user participating in the same project as the user who created the annotation). The search interface 2500 may also provide a “Group Actions” button 2516, which can be configured to perform the same function as “Actions” button across a group of one or more selected annotation entries 2512 (e.g. to export any data from the database 108 associated to the selected annotation entries 2512 to an external file for storage, such as an external file in a Rich Text Format (RTF) or Comma Separated Values (CSV) format). In response to the Group Actions button 2516 detecting a user action (e.g. a mouse click), the annotation system 100 is configured (e.g. under the control of the browser module 112) to generate an updated search interface 2500 including a secondary menu selection component (not shown in FIG. 25) that contains one or more user selectable secondary menu options. The secondary menu options may configure the system 100 to perform the same functions as the primary menu options described above (but only in respect of one or more selected annotation entries 2512).

When a user clicks on an annotation entry 2512, the client 102 generates an annotation display interface 2600, which provides details of the annotation including, for example, the title, description, tags, user, related projects and so on. The annotation display interface 2600 allows users to place comments on the annotation entry 2512, which are shown in the annotation display interface 2600. A comment is a string of text provided by a user of the annotation system 100. Each comment is stored in association with the annotation in the database 108. Each comment may also be associated with a flag status indicator 2602, which allows users to indicate which of the comments for an annotation are considered to be inappropriate (e.g. containing swearing). Alternatively, the flag status indicator 2602 can allow users to indicate which of the comments are most relevant, important or interesting.

FIG. 27 is an example of a page display interface 2700 with a toolbar portion 2702 and a details display portion 2704 that can be hidden or displayed by operation of the toggle button 2706.

Another aspect of the annotation system 100 relates to the analysis server 116. The analysis server 116 is responsible for knowledge management and uses the data gathered from user's activities to discover links and associations between users and annotations stored in the database 108. The analysis server 116 uses these associations in order to recommend novel and interesting new annotations and documents (e.g. web pages) to users. In this way, the analysis server 116 leverages on the array of knowledge generated by users of the annotation system 100 to enrich the experience of other users of the annotation system 100.

The analysis server 116 uses a user/project identifier which represents a specific user and project combination. The user/project identifier may be associated with the actions of a particular user inside of (or relating to) a specific project. The user/project identifier is used to distinguish the activities of a user between different projects, as there may be very different goals in mind for each project.

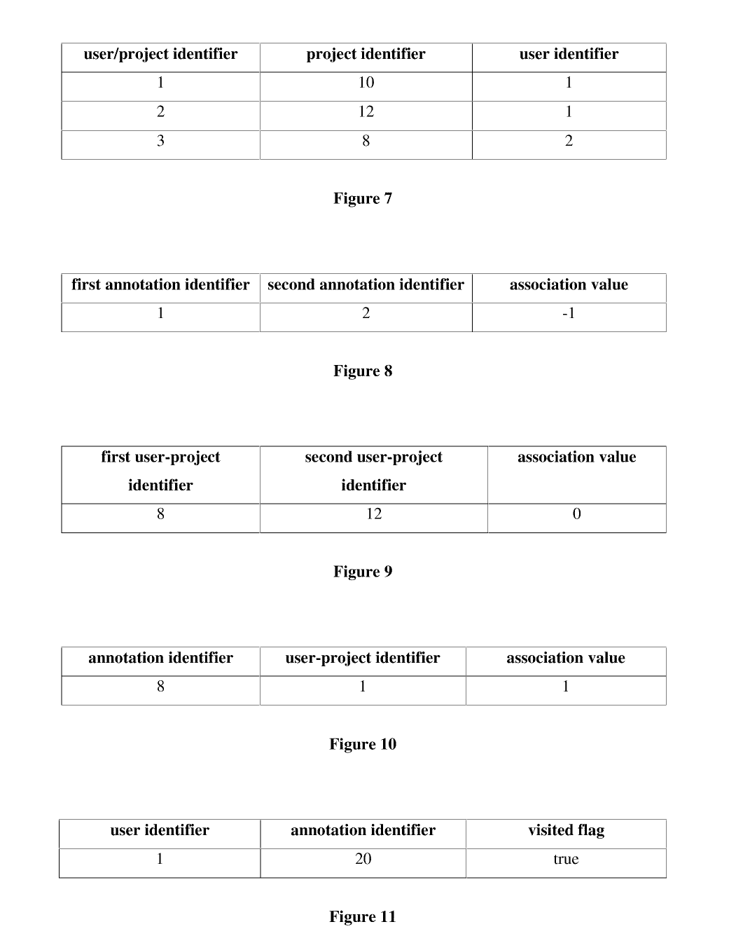

The analysis server 116 uses and maintains the following data structures on the database 108:
annotation index data: which represent an index of parsed terms (words) from the annotation data stored in the database, and includes a fast hash from a query (consisting of terms) back to the documents that contain those terms.
user-project data: (as shown in FIG. 7) which associates each project identifier (for a project) to the user identifiers of one or more users who participate in the project. A unique user-project identifier is associated with each unique combination of project identifier and user identifier.
annotation association data: (e.g. as shown in FIG. 8) which associates a first annotation identifier (for one annotation) and a second annotation identifier (for another annotation) to an association value. The association value may be generated based on:
   the degree of similarity in the metadata for the first and second annotations (e.g. having the same tags, document similarity between their content, etc); or
   inferences from the annotation/project association data (e.g. if the first and second annotations relate to projects that have a high degree of association, the first and second annotations will be treated as similar).
user-project association data: (e.g. as shown in FIG. 9) which associates a first user-project identifier (for one user-project) and a second user-project identifier (for another user-project) to an association value. The association value may be generated based on:
   the degree of similarity in the metadata for the first and second user-projects (as described above); or
   inferences from the annotation/user-project association data (as described above).
annotation/user-project association data: (e.g. as shown in FIG. 10) which associates an annotation identifier (for an annotation) and a user-project identifier (for a user-project) to an association value. The association value may be generated based on:
   annotation actions from users; or
   user visitations to documents (or pages) without annotation; or
   inferences from either the annotation association data or user-project association data (e.g. if Project 1 is highly associated with annotation X and Project 2 is highly associated with Project 1 (from the user-project association data), the system infers that Project 2 is highly associated with annotation X. This then allows smart recommendation of annotation X to user working on Project 2).
visitation data: (e.g. as shown in FIG. 11) which associates a user identifier (for a user) and an annotation identifier (for an annotation) to a Boolean value to indicate whether the user has already previously accessed (and therefore likely to have seen) the annotation represented by the annotation identifier.

The data described with reference to FIGS. 7 to 11 may be provided as separate data structures (e.g. tables) in the database 108. Alternatively, the data described with reference to FIGS. 7 to 11 may represent a portion of a larger data structure in the database 108, but which can be used to perform one or more of the functions as described above.

In one embodiment of the annotation system 100, the analysis server 116 could use the following data structures stored, for example, in the database 108 or locally on the annotation server 116:
project association data: which associates a first project identifier (for one project) and a second project identifier (for another project) to an association value. The association value will be inferred from similarity in user-projects which belong to two projects (referenced in the user-project identification data) detected in the annotation/user-project association data (as described above). This information can be used to help seed the user-project association data. For example, when a new user-project in project X is created, a default association will be generated with not only other user-projects representing other users from project X, but also for instance other user-projects in project Y which is highly associated with project X in the user-project association data.
user association data: which associates a first user identifier (for one user) and a second user identifier (for another user) to an association value. The association value will be inferred from similarity in between different users' user-projects (referenced in the user-project identification data) in the annotation/user-project association data (as described above). This information can be used to help seed the user-project association data. For example, when a new user-project for user X is created, a default association will be generated with not only other user-projects representing the other projects of user X, but also for instance the user-projects of user Y who is highly associated with user X in the user association data.

The association value represents a number selected from a predefined range of numbers, where the values towards one end of the range represent a greater degree of association between the elements in the association table, and the values towards the other end of the range represent a lesser degree of association between the elements in the association table. For example, the association value may range between 1 and −1, where an association value of 1 indicates a positive association, 0 indicates no known association, and −1 indicates a negative association.

The analysis server 116 receives various types of notification input or data input from either the annotation server 106 or client device 102 to perform real-time updates of the data structures described above. For example, the analysis server 116 may receive notification input notification in response to any of the following events:
User visits a page;
Creation, modification or deletion events for annotations, users and projects; and; and
User views an existing annotation.

The analysis server 116 may also receive the following data captured by the annotation server 106 or client device 102:
User data: such as demographic information (e.g. age), organisational capacity (e.g. researcher, lawyer) and organisational unit (e.g. Intellectual Property);
Project information: such as project tags; and
Annotation information: such as the title, annotated text, full page text, tags and the date of annotation.

In response to receiving the notification input or data input, the analysis server 116 may update the data structures described above as follows:
User visits a page/an existing annotation:
   add “true” entries to the visitation data;
Creation/modification/deletion of a project:
   update the user-project identification data accordingly (add or remove rows);
Creation/modification/deletion of a user:
   update the user-project identification data accordingly (add or remove rows);
Creation of user-projects in the identification data (from above process acts):
   Add default association the user-project association table with default associations to other projects of the same user, or other users in the same project;
Deletion of user-projects in the identification data (from above process acts):
   Delete any association of the user-project in the user-project association data and the annotation/user-project association data;
Creation/modification/deletion of an annotation:
   add, modify or delete entries in the annotation index;
   add or delete entries in the annotation association data with default associations to other annotations from the same source or website;
   add or delete entries in the annotation/user-project association data with default association to the user who created it;
when a page is visited but not annotated:
   add an entry to the annotation/user-project association data with negative association.

The analysis server 116 also performs additional independent processing to generate association data linking annotations and users. For example, the analysis server 116 may use the metadata that comes with the annotation/projects association data to update the annotation association data and/or the project association data. This may involve, for example, comparing the titles of various annotations using statistical document similarity algorithms to determine their likely similarity. Annotations with similar titles are treated as being associated with each other. Once this computation has be done for an annotation/user, the system can begin answering more complex queries and making recommendations to users.

The analysis server 116 constantly updates the annotation association data, project association data and annotation/project association data. The system may also perform statistical analysis of the annotation/project association data to discover:
Projects with similar or correlated annotation patterns, where such projects are updated to have a high degree of association in the project association table;
Users with dissimilar or uncorrelated annotation patterns, where such users are updated to have a lower degree of association; and
Annotations with similar or dissimilar usage patterns, where such annotations will be updated to have a higher or lower degree of association (respectively) in the annotation association data.

In addition, the analysis server 116 may use the project association data and the annotation association data to fill in missing values in the annotation/project association data. For example if Project A does not have an association with annotation X, but is highly associated with Project B which has a high degree of association with annotation X, then Project A will be updated to have a high degree of association with annotation X.

By iterating through this updating process, an equilibrium is reached between the three association data structures used by the analysis server 116, which remain in that state until further changes that occur are detected and processed.

The analysis server 116 can respond to comprehensive queries and speculative queries. Comprehensive queries achieve full coverage of the data. Such queries can use the current annotation index to receive a comprehensive listing of the annotations which are relevant to specific query. The annotation/project association data is then used to use the known associations of this user (in this project) to help ranking the annotations in order of both relevance to the query and relevance to the user. If this association data is not up to date, the ranking of the results may not be very useful. But this compromise achieves full coverage whilst still leveraging what association data is available.

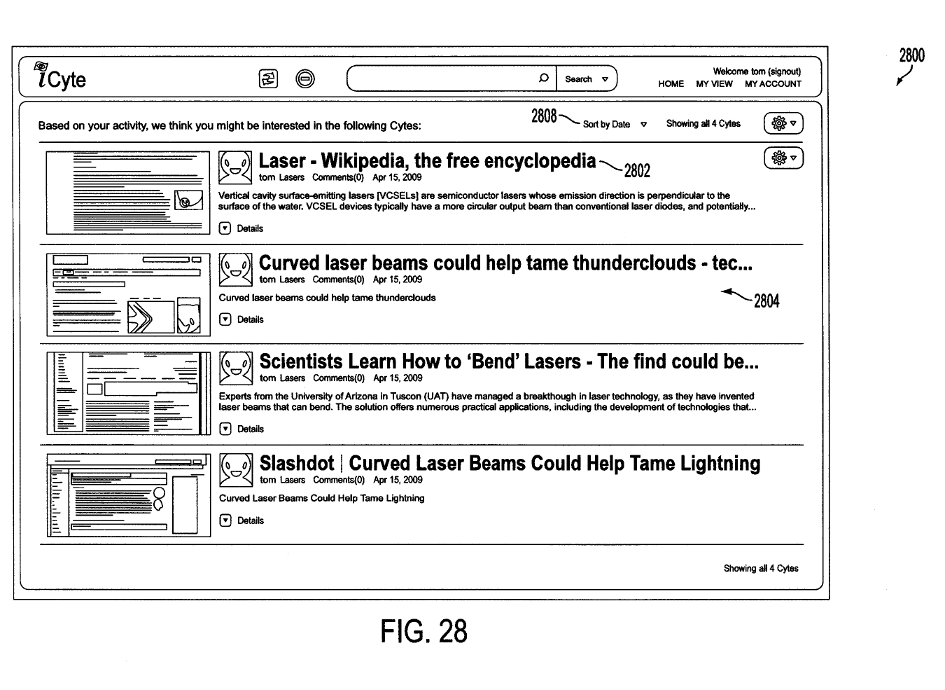

FIG. 28 is an example of a comprehensive query results interface 2800. The results interface 2800 includes a results display portion 2802 that shows one or more annotation entries 2804 in a manner similar to that described with reference to FIG. 25. The annotation entries 2804 displayed in the results interface 2800 may be retrieved based on the relevance of the annotations (or documents) stored in the database 108 to search parameters that have been provided by a user as part of a request to the annotation server 106 (i.e. user “pulled” results) or based on criteria as determined by the annotation server 106 or analysis server 116 (i.e. server “pushed” results).

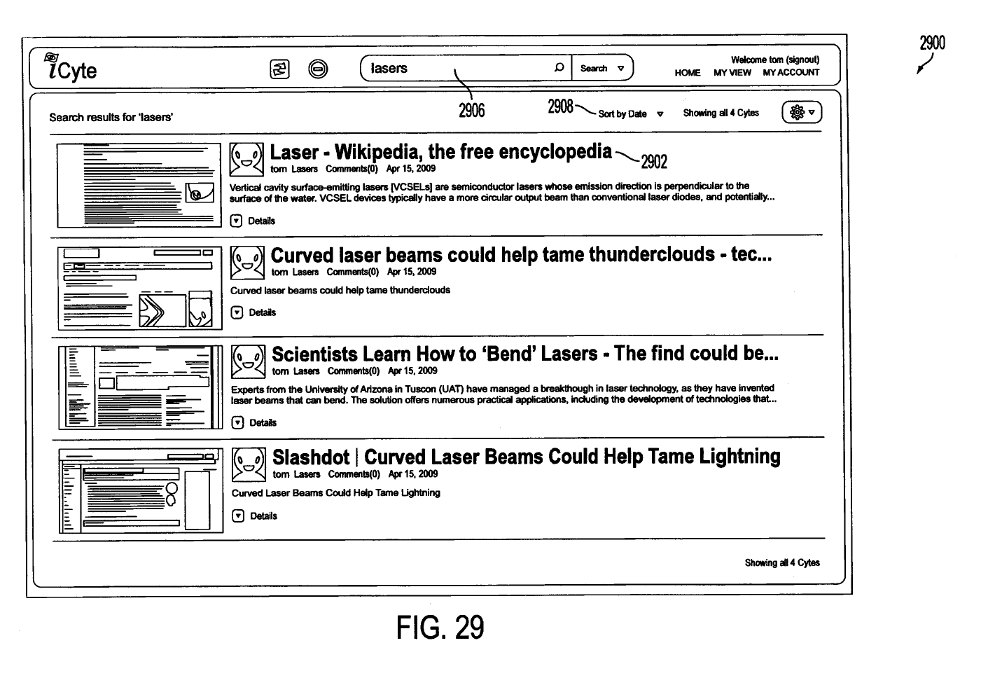

For example, in the “pulled” results scenario, relevance may be determined based on a relationship between the annotations (or documents) stored in the database 108 with one or more keywords or other search parameters provided by a user via the interface 2800. FIG. 29 shows an example of a results interface 2900 where the annotations displayed in the results display area 2902 are retrieved based on the keywords provided in a text input field 2906 of the interface 2900.

In the “pushed” results scenario, relevance may be determined based on the activities of the user when using the system 100. For example, the relevance of an annotation (or corresponding document) may be determined based on the existence of certain keywords in that annotation (or document) that also appear in whole or in part in an annotation, document title, tag, or other metadata associated with an annotation (or corresponding document) belonging to a project in which the user conducting the search using the search interface 2800 is a participant. Of course, relevance can be determined based on other factors by using any relationship that can be determined using one or more of the association data structures described above.

The order of the annotation entries 2804 in the results interface 2800 may be initially specified by the analysis server 116 (e.g. based on the relevance). However, the results interface 2800 may include a sort button 2808 (i.e. item 2908 in the results interface 2900 shown in FIG. 29) that allows the user to selective change the order in which the annotations in the results display area 2802 are displayed. For example, the sorting of annotation entries 2802 will be performed in a similar manner to that described with reference to FIG. 25.

Speculative queries are intended to help the user find information which they have not previously seen. The analysis server 116 may rely on the annotation index to filter out relevant or irrelevant documents (depending on the query). The analysis server 116 uses the annotation/project association data to rank the documents in order of likelihood of being relevant to the user. The analysis server 116 may also use the visitation data to ensure that only unvisited documents (or documents not previously accessed or seen by a particular user) are recommended in the results.

The results interface 2900 shown in FIG. 29 can also be provide results to speculative queries. In a representative embodiment, when a user types in a new character into the text input field 2906, a pop-up window will appear (not shown in FIG. 29) adjacent to the text input field 2906. The pop-up window may contain one or more related keywords that are selected based on relevance to the keywords (or part of keywords) provided in the text input field 2906 (e.g. relevance may be determined in a manner similar to that described above with reference to FIG. 28). Alternatively, the pop-up window may display a selective sample of one or more potentially relevant annotations relating to any of the keywords (or part of keywords) provided in the text input field 2906.

As a further alternative, the system's 100 user interface for providing speculative query functionality may be in the form of a side bar that appears whilst a user is annotating some other website. Another aspect of the annotation system 100 relates to the ability to control user access to annotated documents stored in the database 108. This feature is useful in scenarios where a first user has access to access-restricted content (e.g. a document or web page) from a source that provides such content to the user on the condition of payment (e.g. an access or subscription fee) or upon approval of valid authentication details provided by the user (e.g. a username and password). The first user may use the annotation system 100 to annotate and store a copy of the access-restricted content into the database 108. In some circumstances, it may not be desirable to allow a second user (who does not have the same access privileges as the first user) to have access to the access-restricted content of the first user.

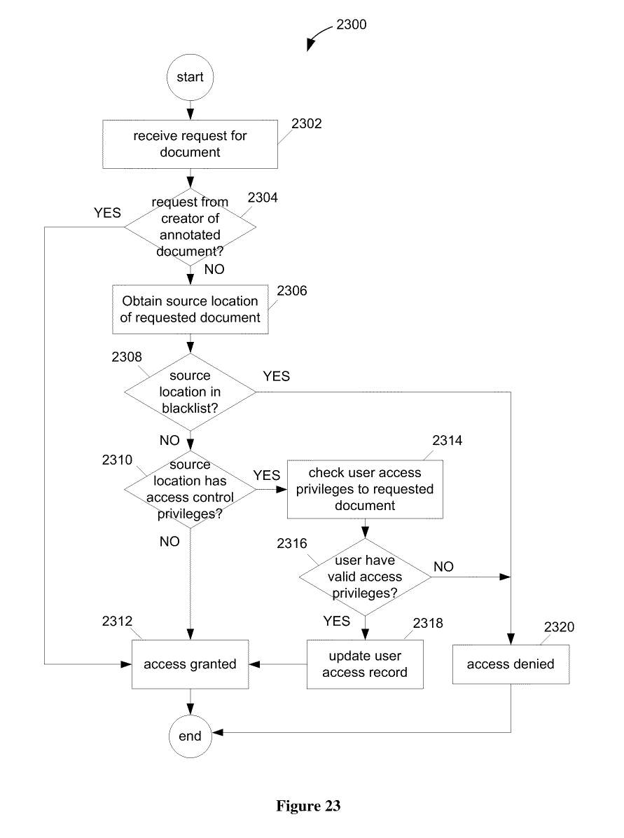

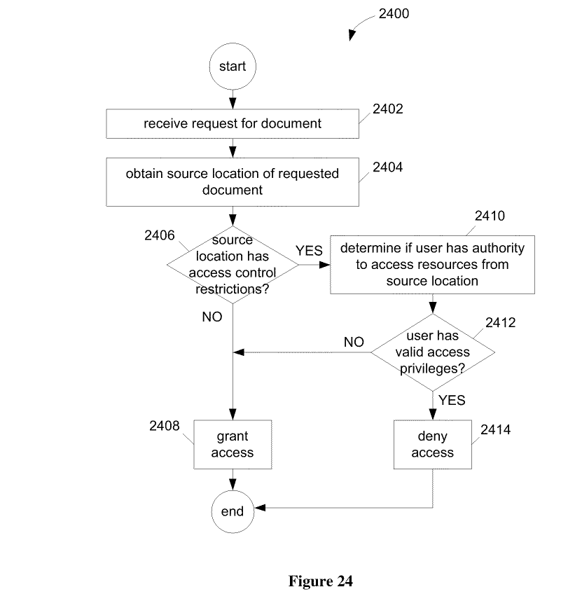

FIG. 23 shows one example of an access control process 2300 for controlling user access to a document stored in the database 108. Process 2300 is performed by the annotation server 106 under the control of an authentication module (not shown in FIGS. 1A and 1B) of the annotation server 106. The annotation system 100 may control user access to documents stored by the annotation system 100 using any suitable access control technique, process or component, and thus is not limited to the processes described with reference to FIGS. 23 or 24.

The access control process 2300 begins at 2302 where the annotation server 106 receives a request from the client device 102 for accessing an annotated document stored in the database 108. At 2304, the annotation server 106 determines whether the request came from the user who created the annotated document. If so, 2304 proceeds to 2312 to grant the user access to the requested document. Otherwise, 2304 proceeds to 2306.

At 2306, the annotation server 106 retrieves the source location (e.g. URL) of the document identified in the request. At 2308, the annotation server 106 checks whether the source location corresponds to one of the source locations stored in the “blacklist”. The “blacklist” contains blacklist data representing one or more source locations of content providers who do not wish to make their content (from those source locations) accessible to unauthorised or non-subscriber users. If the source location of the document matches an entry in the blacklist data, 2308 proceeds to 2320 where the user is denied access to the requested document. Otherwise, 2308 proceeds to 2310.

At 2310, the annotation server 106 queries site access privilege data to check whether there the source location for the document has any associated access privileges to control access by users. The access privileges associated with a document may, for example, include data identifying the users (e.g. one or more user identifier, or the IP address or domain of specific users) or type of users (e.g. one or more user/project identifiers, or enterprise identifiers representing all users of an organisation or a department of such an organisation) who can have access to the document. If not, 2310 proceeds to 2312 to grant the user access to the requested document. Otherwise, 2310 proceeds to 2314.

At 2314, the annotation server 106 obtains the user's access privileges (i.e. the user who sent the query) using process 2400. The user's access privilege may include authentication data (e.g. a user name and password) that the annotation server 106 uses to query the content provider to confirm that the user is entitled to access content from that content provider. The user's access privilege may also include status flag data that indicates whether a user has self-declared (or manual checks have been made to confirm) that the user is entitled to access the content from the particular content provider. A record is maintained in 2318 in the event that a user is later found not to have proper authorisation to access the requested document. A user is provided an opportunity to provide details of the user access privilege if this has not been provided previously.

At 2316, the user's access privileges are compared with the access privileges for the requested document. If the comparison at 2316 determines that the user's access privileges are consistent with the access privileges of the requested document, then at 2314, the user access record data stored in the database 108 is updated, and at 2312 the user is granted access to the requested document.

The user access record data represents at least the user identifier (of the user who access the document), document identifier (of the requested document) and the date and time of when the requested document was accessed. The user access record data provides a useful record to prove whether a user accessed a particular document at a particular time. One embodiment of the annotation system 100 includes a reporting function which generates reports of user access activities to relevant content providers. Another embodiment of the annotation system 100 include a payments module that uses the user access record data to process access/royalty payments to the relevant content provider upon allowing access to the requested document. However, if the comparison at 2316 determines that the user's access privileges are inconsistent with the access privileges of the requested document, then the user is denied access to the requested document at 2320.

FIG. 24 shows another example of an access control process 2400 for controlling user access to a document stored in the database 108. Process 2400 is performed by the annotation server 106 under the control of an authentication module (not shown in FIGS. 1A and 1B) of the annotation server 106. The access control process 2400 begins at 2402 where the annotation server 106 receives a request from the client device 102 for accessing an annotated document stored in the database 108.

At 2404, the annotation server 106 retrieves the source location (e.g. URL) of the document identified in the request. At 2406, the annotation server 106 queries the database 108 to determine whether resources obtained from the source location (retrieved at 2404) is subject to any access control restrictions. For example, the source location may be a website or electronic resource that provides content to authorised users on a paid subscription basis, and therefore does not allow access to users who do not have a current subscription. If the response from the database 108 indicates that access control restrictions apply to content obtained from the source location, then 2404 proceeds to 2410 for further processing. Otherwise, 2406 proceeds to 2406 to allow the user access to the requested document, and process 2400 ends.

At 2410, the annotation server 106 determines whether the user who initiated the request at 2402 has authority to access resources from the source location. This can be carried out in a number of ways. For example, the database 108 may include data representing rules or other assessment criteria for the annotation server 106 to determine whether a user should be granted or denied access to an annotated document in the database 108 obtained from the source location. For example, the rules/criteria may define one or more specific users who are allowed (or denied) access to the requested document. The rules/criteria may define a range of one or more IP addresses (or other network or communications address) of users who are allowed (or denied) access to the requested document. The rules/criteria may also require the user who initiated the request at 2402 to perform authentication with an external server (e.g. with a server that controls access to content from the source location) where the annotation server 106 determines that the user is allowed access to the requested document after receiving a response confirming that the user has been successfully authenticated by the external server.

At 2412, the annotation server 106 determines whether the analysis at 2410 indicates that the user should be granted access to the requested document. If so, 2412 proceeds to 2408 where the user is granted access to the requested document. Otherwise, 2412 proceeds to 2414 to deny the user access to the requested document. Process 2400 ends after performing 2408 or 2414.

Any of the processes or methods described herein can be computer-implemented methods, wherein the described acts are performed by a computer or other computing device. Acts can be performed by execution of computer-executable instructions that cause a computer or other computing device (e.g., client device 102, annotation server 106, analysis server 116, content server 107, a special-purpose computing device, or the like) to perform the described process or method. Execution can be accomplished by one or more processors of the computer or other computing device. In some cases, multiple computers or computing devices can cooperate to accomplish execution.

One or more computer-readable media can have (e.g., tangibly embody or have encoded thereon) computer-executable instructions causing a computer or other computing device to perform the described processes or methods. Computer-readable media can include any computer-readable storage media such as memory, removable storage media, magnetic media, optical media, and any other tangible medium that can be used to store information and can be accessed by the computer or computing device. The data structures described herein can also be stored (e.g., tangibly embodied on or encoded on) on one or more computer-readable media.

The annotation system 100 can provide many technical advantages. For example, the annotation system 100 provides a way of capturing and storing an electronic document (including any annotations) which can be retrieved for display at a later point in time. This reduces the risk that a user may lose relevant information contained in a document at time of capture, such as if the electronic resource is later removed from a website or is updated with new information (e.g. on a news web page). Also, a user's annotations to a document are accurately maintained, and are not affected by any changes to the (live) document made after creating the annotation. A further technical advantage relates to the document capture process in which the client device 102 provides the annotation server 106 with the core resources of the document together with a list of non-core resources. The annotation server 106 then automatically retrieves the non-core resources identified in the list (without further interaction with the client device 102), which minimises the communications load between the client device 102 and annotation server 106.

Modifications and improvements to the invention will be readily apparent to those skilled in the art. Such modifications and improvements are intended to be within the scope of this invention.

Although the annotation system 100 is described in the context of a client-server system, the processes performed by the annotation server 106, database 108 and/or analysis server 116 can be performed on the client device 102. Alternatively, the processes performed by the client device can, at least in part, be performed by annotation server 106 (e.g. to minimise the need to install and execute code on the client device).

The word ‘comprising’ and forms of the word ‘comprising’ as used in this description does not limit the invention claimed to exclude any variants or additions. In this specification, including the background section, where a document, act or item of knowledge is referred to or discussed, this reference or discussion is not an admission that the document, act or item of knowledge or any combination thereof was at the priority date, publicly available, known to the public, part of common general knowledge, or known to be relevant to an attempt to solve any problem with which this specification is concerned.

1. A system for annotating electronic documents, said system comprising at least one processing module configured to:
i) access an electronic document;
ii) access a user selected portion of the contents of said document;
iii) generate annotation data for said portion, said annotation data comprising position data representing a relative location of said portion within a subset of the contents of said document;
iv) control a data store to store data comprising document data representing the contents of said document, said annotation data, and resources data representing any data items referenced by said document; and
v) generate, based on at least said annotation data from said data store, a graphical display comprising a unique graphical representation of said portion.

2. A system as claimed in claim 1, wherein said annotation data comprising one or more selected from the group consisting of:
a) selection data representing at least the content within said portion;
b) tag data representing one or more topic identifiers associated with said portion;
c) a unique subset identifier for each different subset defined within the contents of the document; and
d) description data representing a description relating to said portion.

3. A system as claimed in claim 1, wherein said position data represents the start of said portion as a first character offset position relative to the first character in said subset.

4. A system as claimed in claim 1, wherein said position data represents the end of said portion as a second character offset position relative to the last character in said subset.

5. A system as claimed in claim 1, wherein said position data represents a plurality of coordinate positions relative to a reference point in said document.

6. A system as claimed in claim 1, wherein said action (i), (ii), (iii) and (v) are performed on a client machine, and said action (iv) is performed on a server machine.

7. A system as claimed in claim 1, wherein if said server is unable to access a specific data item represented by said resources data, said server controls said client to retrieve said specific data item and send said specific data item to said server for storage.

8. A system as claimed in claim 1, wherein said document data comprising data representing one or more said data items for defining display attributes for said document.

9. A system as claimed in claim 1, wherein said resources data represents one or more said data items for rendering for display in connection with said document, wherein one of said data items comprising an image.

10. A system as claimed in claim 1, wherein said document is a structured language document.

11. A system as claimed in claim 1, wherein said document comprises any one selected from the group consisting of:
i) a hypertext markup language (HTML) data;
ii) a portable document format (PDF) data;
iii) a rich text format (RTF) data;
iv) an extensible markup language (XML) data;
v) text data;
vi) data prepared for use in a word processing application; and
vii) data prepared for use in a spreadsheet application.

12. A system as claimed in claim 1, wherein said graphical display comprises a first graphical representation of said document as accessed by the system, and said unique graphical representation of said portion differs from said first graphical representation by one or more display criteria selected from the group consisting of:
i) font type;
ii) font size;
iii) font colour;
iv) font style;
v) background colour corresponding to the selected portion;
vi) a visual embellishment adjacent to the selected portion; and
vii) at least one selected from the group consisting of the opacity, colour and border attribute for a region representing the selected portion.

13. A system as claimed in claim 1, wherein said graphical display represents a summary representation of one or more of said selected portions from one or more different said documents.

14. A system as claimed in claim 1, wherein said data store comprises annotation association data representing a degree of relevance between the annotation data for a first annotation and the annotation data for a second annotation, wherein each said annotation corresponds to a different said selected portion.

15. A system as claimed in claim 1, wherein said data store comprises project association data representing a degree of relevance between the annotation data for a first project and the annotation data for a second project, wherein each said project is associated with annotation data representing one or more of said annotations, and each said annotation corresponds to a different said selected portion.

16. A system as claimed in claim 14, wherein said degree of relevance is represented by an association value selected from a predefined range of values, wherein said selection is based on the similarity of the contents represented by the respective annotation data for said first annotation and said second annotation.

17. A system as claimed in claim 15, wherein said degree of relevance is represented by an association value selected from a predefined range of values, wherein said selection is based on the similarity of the contents represented by the respective annotation data for the annotations for said first project and the annotations for said second project.

18. A system as claimed in claim 14, wherein said system comprises generating, based on a query and at least one selected from the group consisting of said annotation association data and said project association data, said graphical display comprising one or more annotations associated to one or more parameters of said query.

19. A system as claimed in claim 18, wherein said data store comprises visitation data representing one or more annotations that a user has viewed in connection one of said projects.

20. A system as claimed in claim 19, wherein said graphical display excludes any said annotations that are identified in said visitation data.

21. A system as claimed in claim 1, wherein said system is configured to generate search interface for receiving one or more search parameters from a user for controlling said at least one processor to search for one or more related said selected portions stored in the data store.

22. A system as claimed in claim 21, wherein said one or more search parameters comprise one or more selected from the group consisting of:
i) a keyword;
ii) a tag comprising of text;
iii) a project identifier; and
iv) a user identifier.

23. A system as claimed in claim 21, wherein said system is configured to generate a results interface for displaying to a user said one or more related said selected portions.

24. A system as claimed in claim 23, wherein said results interface is selectively configurable by a user to arrange said one or more related said selected portions according to at least one of an alphabetical, numeric or chronological order.

25. A system as claimed in claim 21, wherein said system is configured so that a user can, based on a user action, selectively perform, in respect to a selected group of said one or more related said selected portions displayed in said results interface, selectively perform one or more selected from the group consisting of:
i) associate said group with a project representing a set of one or more other said selected portions;
ii) modify a description, tags or attributes associated with said group;
iii) transmit a network address for accessing said group; and
iv) delete said group from said data store.

26. A system as claimed in claim 1, wherein said annotation data comprises comments data representing one or more comments, each comment comprising a string of characters provided by a user of said system.

27. A system as claimed in claim 1, wherein said comments data comprises flag status data representing one of two modes of selections which are interchangeably selectable based on a user action.

28. A method for annotating electronic documents, comprising:
i) accessing an electronic document;
ii) accessing a user selected portion of the contents of said document;
iii) generating, in a computing device, annotation data for said portion, said annotation data comprising position data representing a relative location of said portion within a subset of the contents of said document;
iv) controlling a data store to store data comprising document data representing the contents of said document, said annotation data, and resources data representing any data items referenced by said document; and
v) generating, based on at least said annotation data from said data store, a graphical display comprising a unique graphical representation of said portion.

29. A system for annotating electronic documents, said system comprising at least one processing module configured to:
i) access an electronic document providing contents based on a structure;
ii) generate document data representing said contents, comprising data for uniquely identifying different predefined subsets of said contents based on said structure;
iii) access a user selected portion of the contents of said document;
iv) generate annotation data for said portion, said annotation data comprising position data representing a relative location of said portion within at least one of said predefined subsets;
v) control a data store to store data comprising said document data, said annotation data, and resources data representing any data items referenced by said document; and
vi) generate, based on at least said annotation data from said data store, display data representing a graphical user interface comprising a unique graphical representation of said portion.

30. A method for annotating electronic documents, comprising:
i) accessing an electronic document providing contents based on a structure;
ii) generating document data representing said contents, comprising data for uniquely identifying different predefined subsets of said contents based on said structure;
iii) accessing a user selected portion of the contents of said document;
iv) generating, in a computing device, annotation data for said portion, said annotation data comprising position data representing a relative location of said portion within at least one of said predefined subsets;
v) controlling a data store to store data comprising said document data, said annotation data, and resources data representing any data items referenced by said document; and
vi) generating, based on at least said annotation data from said data store, display data representing a graphical user interface comprising a unique graphical representation of said portion.

31. A system for annotating electronic documents, comprising:
a processor component;
a display configured for displaying, to a user, a graphical user interface comprising a graphical representation of the contents of an electronic document accessed by said system;
a cursor component being selectively moveable to any position within said display based on a first user action, and being responsive to a second user action for selecting a portion of said contents shown within said display; and
an annotation component that can be selectively activated and deactivated by a user, so that when said annotation component is activated, said annotation component:
i) generates document data representing the contents of said document, comprising data for uniquely identifying different predefined subsets of said contents;
ii) in response to detecting a user selecting said portion, generates annotation data for said portion, said annotation data comprising position data representing a relative location of said portion within at least one of said predefined subsets;
iii) controls a data store to store data comprising said document data, said annotation data, and resources data representing any data items referenced by said document; and
iv) generates, based on at least said annotation data from said data store, display data representing an updated said graphical user interface comprising a unique graphical representation of said portion.

32. A system as claimed in claim 31, wherein:
said display is configured for displaying, to said user, a graphical user interface comprising a text input component for receiving input from said user representing a string of one or more text characters;
wherein, when said system detects an additional character being entered into said text input component by said user, said system:
a) separates said string into one or more keywords;
b) accesses from said data store the document data, the annotation data and the resources data for one or more matching documents having a said portion containing data relating to at least a part of any one of said keywords; and
c) generates, based on at least the annotation data for each of said matching documents, display data representing an updated said graphical user interface comprising a separate graphical representation for each of said matching documents.

33. A system as claimed in claim 31, wherein:
said display is configured for displaying, to said user, a graphical user interface comprising a primary menu component providing one or more primary user selectable options, said primary menu component being adapted for receiving input from said user representing a selection of one or more of said primary options in response to a third user action;
wherein, when said system detects the selection of one of said primary options in response to said third user action, said system:
a) generates query data representing search parameters relating to each of the different said selected options;
b) accesses from said data store the document data, the annotation data and the resources data for one or more matching documents having a said portion relating to data, in said data store, corresponding to any one of said search parameters; and
c) generates, based on at least the annotation data for each of said matching documents, display data representing an updated said graphical user interface comprising a separate graphical representation for each of said matching documents.

34. A system as claimed in claim 32, wherein said separate graphical representation for a particular one of said matching documents is a pictorial representation of at least a selected said portion of the particular said document.

35. A system as claimed in claim 33, wherein said separate graphical representation for a particular one of said matching documents is a pictorial representation of at least a selected said portion of the particular said document.

36. A system as claimed in claim 32, wherein:
said display is configured for displaying, to said user, a graphical user interface comprising a first selection button component for receiving input from said user in response to a fourth user action;
wherein, when said system detects said fourth user action, said system generates, based on at least the annotation data for each of said matching documents, display data representing an updated said graphical user interface comprising a separate graphical representation for each of said matching documents in a predetermined order, said order being at least one selected from the group consisting of:
a) a chronological order;
b) an alphabetical order based on at least one of a project name, user name, title, or tag associated with said portion; and
c) an order based on relevance of each of said matching documents to any of said keywords or search parameters.

37. A system as claimed in claim 33, wherein:
said display is configured for displaying, to said user, a graphical user interface comprising a first selection button component for receiving input from said user in response to a fourth user action;
wherein, when said system detects said fourth user action, said system generates, based on at least the annotation data for each of said matching documents, display data representing an updated said graphical user interface comprising a separate graphical representation for each of said matching documents in a predetermined order, said order being at least one selected from the group consisting of:
a) a chronological order;
b) an alphabetical order based on at least one of a project name, user name, title, or tag associated with said portion; and
c) an order based on relevance of each of said matching documents to any of said keywords or search parameters.

38. A system as claimed in claim 32, wherein:
said display is configured for displaying, to said user, a graphical user interface comprising a second selection button component for receiving input from said user in response to a fifth user action;
wherein, when said system detects said fifth user action, said system generates an updated said graphical user interface comprising a secondary menu component providing one or more secondary user selectable options, said secondary menu component being adapted for receiving input from said user representing a selection of one of said secondary options in response to a sixth user action;
wherein, when said system detects the selection of one of said secondary options in response to said sixth user action, said system is configured to perform, with respect to a preselected one or more of said matching documents, a function corresponding to the selected secondary option that is selected from the group consisting of:
a) adding the one or more preselected matching documents to a particular project;
b) moving the one or more preselected matching documents to a different project;
c) modifying an attribute relating to each of the one or more preselected matching documents;
d) creating a duplicate of the one or more preselected matching documents in said data store;
e) generating a message containing a reference to each of the one or more preselected matching documents; and
f) deleting the one or more preselected matching documents from said data store.

39. A system as claimed in claim 33, wherein:
said display is configured for displaying, to said user, a graphical user interface comprising a second selection button component for receiving input from said user in response to a fifth user action;
wherein, when said system detects said fifth user action, said system generates an updated said graphical user interface comprising a secondary menu component providing one or more secondary user selectable options, said secondary menu component being adapted for receiving input from said user representing a selection of one of said secondary options in response to a sixth user action;
wherein, when said system detects the selection of one of said secondary options in response to said sixth user action, said system is configured to perform, with respect to a preselected one or more of said matching documents, a function corresponding to the selected secondary option that is selected from the group consisting of:
a) adding the one or more preselected matching documents to a particular project;
b) moving the one or more preselected matching documents to a different project;
c) modifying an attribute relating to each of the one or more preselected matching documents;
d) creating a duplicate of the one or more preselected matching documents in said data store;
e) generating a message containing a reference to each of the one or more preselected matching documents; and
f) deleting the one or more preselected matching documents from said data store.

40. A computer program product, comprising a computer readable storage medium having computer-executable program code embodied therein, said computer-executable program code adapted for controlling a processor to perform a method for annotating electronic documents, said method comprising:
i) accessing an electronic document;
ii) accessing a user selected portion of the contents of said document;
iii) generating annotation data for said portion, said annotation data comprising position data representing a relative location of said portion within a subset of the contents of said document;
iv) controlling a data store to store data comprising document data representing the contents of said document, said annotation data, and resources data representing any data items referenced by said document; and
v) generating, based on at least said annotation data from said data store, a graphical display comprising a unique graphical representation of said portion.
